(19) United States
(12) Patent Application Publication
(10) Pub. No.: US 2018/0293103 A1
(43) Pub. Date: Oct. 11, 2018

(54) AUGMENTED INTELLIGENCE RESOURCE ALLOCATION SYSTEM AND METHOD

(71) Applicant: DIARISSIMA Corp., Campo Grande (BR)

(72) Inventors: Normann Kalmus, Campo Grande (BR); Reinaldo de Andrade Silva, Campo Grande (BR); Daniel Freitas, Campo Grande (BR)

(21) Appl. No.: 15/947,678

(22) Filed: Apr. 6, 2018

Related U.S. Application Data
(60) Provisional application No. 62/482,497, filed on Apr. 6, 2017.

(51) Int. Cl. G06F 9/50; H04L 29/08; G06N 5/02; G06N 3/02; G10L 15/22; G06F 17/30

(52) U.S. Cl. CPC G06F 9/5005; H04L 67/306; G06F 17/30604; G06N 3/02; G10L 15/22; G06N 5/02

(57) ABSTRACT

Aspects of the example implementations are directed to methods and systems associated with allocation of resources. An example computer-implemented method includes maintaining a knowledge base of profiles for environmental elements and a group of users. Each profile can include dependencies, skills, and ratings. The method analyzes a request from a user for a service to determine a set of resource parameters, determines relationships for each profile in the knowledge base in view of the request, and generates a ranking model based at least on the dependencies of the determined relationships in view of the resource parameters. The augmented intelligence can prompt the user for feedback and input, adjusts the ranking model based on similarity calculations of the profiles in view of ratings from the user, and provides options based on the adjusted ranking model that satisfy the resource parameters.

### RELATED APPLICATION INFORMATION

This application is a continuation of U.S. Provisional Patent Application No. 62/482,497, filed on Apr. 6, 2017, which is incorporated herein by reference in its entirety as set forth in full.

### BACKGROUND

### 1. Technical Field

The implementations described herein are related to augmented intelligence, and more particularly to augmented intelligence for resource allocation systems and methods.

### 2. Related Art

“Artificial intelligence” in general terms allows systems to function autonomously in a given domain by reproducing human cognition in its environment to pursue goals. “Intelligence augmentation” (IA) in general terms enables system to supplement and supports human thinking, analysis, and planning. IA integrates a human actor to determine intentionality of the system. Intelligence augmentation is directed to the human-computer interaction (HCI), rather than computers alone.

Information asymmetry refers to the study of decisions in transactions where one party or system has more or better information than the other. Related art studies have shown that information asymmetry creates an imbalance of power (e.g., adverse selection, moral hazard, information monopoly, etc.) in transactions and can cause unintended consequences, inefficiencies, or the transactions to fail altogether.

A value chain is a set of activities that when executed creates value for its customers. The value chain is based on the process view of organizations (e.g., planning, manufacturing, delivering, servicing, etc.), made up of subsystems each with inputs, transformation processes and outputs. Inputs, transformation processes, and outputs involve the acquisition and consumption of resources.

A conventional approach to understanding sources of value for a general-purpose value chain includes examining a corpus of activities, identifying connections; and determining costs in view of profits. According to the traditional Porter value chain approach, activities are classified and analyzed as support activities verses primary activities. However, consideration for each process itself as a chain value of smaller processes can result in identifying tight margins with little comparative advantages.

Related art studies have shown artificial intelligent agents can decrease the degree of information asymmetry. However, organizational processes and complex transactions typically involve a large number of stakeholders, human interaction, and/or inaccessible information decreasing the effectiveness of fully autonomous artificial intelligent approaches. Traditional human-computer interaction systems include a high degree of information asymmetry and are inefficient. Accordingly, there is an unmet need for human-computer interactions systems that integrate up-to-date information across several sources in real-time to determine intelligent value propositions for human operators.

### SUMMARY

According to an example implementation, a computer-implemented method is provided. Aspects of example implementations relate to at least a system and method for integrating augmented intelligence to offer advantageous opportunities that minimize cost related to activities of a target user. In an example implementation, a user specifies a target activity and an augments intelligence system receives information from various sources in real-time to identify and present to the user appropriated alternatives for the for target activity using data analytics and validation techniques.

Aspects of the example implementations are directed to methods and systems associated with allocation of resources. An example computer-implemented method includes maintaining a knowledge base of profiles for environmental elements and a group of users. Each profile can include dependencies, skills, and ratings. The method analyzes a request from a user for a service to determine a set of resource parameters, determines relationships for each profile in the knowledge base in view of the request, and generates a ranking model based at least on the dependencies of the determined relationships in view of the resource parameters. The augmented intelligence can prompt the user for feedback and input, adjusts the ranking model based on similarity calculations of the profiles in view of ratings from the user, and provides options based on the adjusted ranking model that satisfy the resource parameters.

An example aspect of the augments intelligence system reduces inefficiencies of processes and hidden costs. As information is updated, costs and benefits of options are reassessed to determine recommendations and present replacement opportunities to one or more stakeholders.

The methods are implemented using one or more computing devices and/or systems. The methods may be stored in computer-readable media. In an example implementation, the method is a cloud service that can service requests from other platforms via an application interface.

### BRIEF DESCRIPTION OF THE DRAWINGS

FIG. 1 illustrates a block diagram of an example system in accordance with one or more implementations of the present disclosure;

FIG. 2 a flow diagram of an example work order process in accordance with one or more implementations of the present disclosure;

FIG. 3 is a flow diagram of an example of augmented intelligence allocation process in accordance with one or more implementations of the present disclosure;

FIG. 4 is a flow diagram of an example request input process in accordance with one or more implementations of the present disclosure;

FIG. 5 a flow diagram of an example evaluation process in accordance with one or more implementations of the present disclosure;

FIG. 6 illustrates an example computing environment with an example computer device suitable for use in some example implementations;

FIG. 7 provides a block diagram illustrating an example computing device or system that may be used in connection with various example implementations described herein;

FIG. 8 illustrates a block diagram of one implementation of a computing device;

FIGS. 9-51 illustrate example user interactions with the augmented intelligence allocation process according to example implementations as described herein.

### DETAILED DESCRIPTION

The subject matter described herein is taught by way of example implementations. Various details have been omitted for the sake of clarity and to avoid obscuring the subject matter. The examples shown below are directed to structures and functions for implementing systems and methods for determining resource assignments using augmented intelligence. Augmented intelligence systems described herein enhance decision making using human-computer interaction integrated with artificial intelligence deep learning for recourse allocation to recommend superior opportunities with increased efficiency that would otherwise be unknown.

Aspects of the example implementations are directed to methods and systems associated with allocation of resources in an online application. More specifically, a non-transitory computer readable medium coupled to a processor is provided, to process operations or steps associated with the following disclosure. For example, but not by way of limitation, processing is performed that is associated with gathering of data, organizing data and generating information, synthesizing information, distributing information and generating a knowledge base. The operations are implemented in the non-transitory computer readable medium and are provided as a human-computer interaction (HCI) via a variety of interfaces.

As described herein, systems and methods for integrating augmented intelligence offer advantageous opportunities that minimize cost related to activities of a user, a group, an organization, a community, etc. In an example implementation, a user specifies a target activity and an augmented intelligence system receives information from a variety of sources in real-time to identify and present to the user appropriated questions and/or alternatives for the for target activity using data analytics and validation techniques.

According to an example implementation, a system maintains a knowledge base of information that is gathered, organized, and linked using artificial intelligence to environmental elements (e.g., people, machines, suppliers, etc.). The system can learn behaviors of stakeholders that are synthesized with the knowledge base of information. The augmented intelligence system enables virtual, real world, and hybrid transactions.

For example, a weekly milk purchase transaction can typically require a person to visit a store, schedule a delivery service, or solicit a family member to complete the request. The augmented intelligence system can leverage a knowledge base of behaviors, schedules, prices, etc. to identify costs, relationships, and unknowns to determine a set of cost-effective (e.g., prince, time, convenience, preference, etc.) options to complete the transaction in an efficient manner. For example, the system can present the user with potential alternatives and savings such as scheduling a delivery using the same service as a neighbor to get a discount or quicker delivery time.

In an example implementation, the system integrates with existing interfaces to provide a HCI tool (e.g., a mobile application, avatar skill, etc.) to interact with the user and other stakeholders to reduce information asymmetry. For example, the HCI tool can review travel schedules of family members to identify an efficient detour to a store with a competitive price and prompt the user or family members to confirm their availability, costs, and willingness to complete the task via the detour.

According to example implementations, a stakeholder (e.g., a user) can initiate a transaction or the system can detect or predict a user behavior to trigger the transaction. The system can access real-time information and prompt the stakeholder for salient information to assess the value proposition of opportunities to improve the outcome of the transaction. The HCI tool can facilitate an entire transaction and include or be operatively coupled to other interfaces including data collection, communication interfaces, payment processing systems, etc.

An example aspect of the augments intelligence system reduces inefficiencies of processes and hidden costs. As information is updated, costs and benefits of options are re-assessed to determine suitability and replacement opportunities are provided for evaluation, feedback, and/or execution by one or more stakeholders.

Aspects of the example implementation are described in reference to personal and workplace environments involving a primary user and/or group of other users. However, the scope of the example implementations are not limited to a specific environment or arrangement of users, and other environments or configurations may be substituted therefor without departing from the inventive scope. For example, but not by way of limitation, other environments in which the augmented intelligence opportunities can be conducted can include recreational environments, industrial applications, monetary transactions, other than an office or workplace, such as a community group, therapeutic environments, etc., but are not limited thereto.

Further, example interface of the augmented intelligence human-computer interactions systems and methods are described and illustrated as a graphical user interface on a mobile device. However, the scope of the example implementations are not limited to a specific type of interface or device, and other interactive interfaces such as an audio interface or implementations may be substituted therefor without departing from the inventive scope. While the FIGs. provide a description of a series of operations in sequence, certain operations or sequences can be switched, substituted or otherwise modified as would be understood by those skilled in the art at the time of the invention without departing from the inventive scope. For example, but not by way of limitation, other interactive interfaces in which the augmented intelligence opportunities can be integrates with or interact via can include industrial control machines, enterprise planning software applications, gesture recognition, artificial intelligence bots, avatar skills, smart speakers, security systems, augmented or virtual reality glasses, holograms, etc.

Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The human-computer interactions systems methods can integrate up-to-date information across several sources in real-time to determine intelligent value propositions for a community of human operators. The augmented intelligence methods and systems unlock potential savings in value chains by applying artificial intelligence, deep learning, and neural networks to learn relationships across an entire value chain and provide intelligent options or questions to service a request via an interactive selection process. The augmented intelligence methods and systems improve efficiency and optimize value for tangible and intangible resource allocation of a value chain. The interactive selection process allows inaccessible information, evaluations, and conflict resolution to be factored into each transaction while leveraging market imperfections of the value chain.

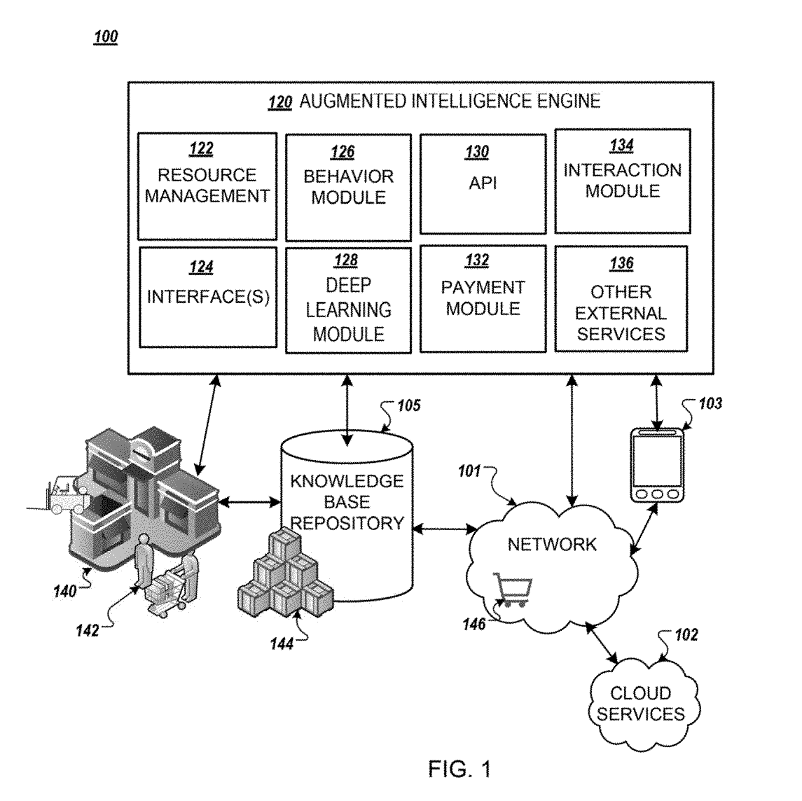

FIG. 1 illustrates a block diagram of an example system 100 in accordance with one or more implementations of the present disclosure. According to an example implementation, a system and method is provided for augmented intelligence to service requests from a user. The augmented intelligence engine 120 can provide the service via communication interfaces 124 that can interact with other platforms such as artificial intelligence platforms, messaging service, user devices, online portals, etc. that allow the user to interact with the augmented intelligence engine 120.

For example, the augmented intelligence engine 120 includes an Application Program Interface (API) 130 for receiving requests. In another example, the augmented intelligence engine 120 can include a user interface to directly interact with the user. The user may employ any electronic device 103 such as, but are not limited to, smartphones, tablets, laptops, computers, telephones (mobile or non-mobile), microphones, camera, and other wireless communication devices to send requests, evaluations, feedback, etc. and receive a set of recommended options in response to the request.

The augmented intelligence engine 120 may include, but is not limited to, a set of instructions capable of being executed in a non-transitory computer readable medium. The instructions may reside in an electronic device at the side of the user (e.g., the client side), at a remote location (e.g., a server side or in a cloud computing environment), or a combination thereof, or on other client devices in a shared processing environment.

According to an example implementation, the augmented intelligence engine 120 includes a resource management module 122, interface module 124, behavior module 126, a deep learning module 128, an API module 130, payment processing module 132, an Interaction module 134, and other external services module 136.

System 100 can include one or more networks 101 that can connect to multiple environments or online sources, for example, user information sources, proprietary information sources, third-party information providers, public information sources, etc. The augmented intelligence engine 120 can gather data and receive requests via the network 101 from various platforms or sources such as cloud services 102, artificial intelligence platforms, messaging platform, user devices, Internet of Things devices, websites, etc.

The system 100 may also include one or more storage devices such as a knowledge base repository 105 or cloud storage. In an example, a knowledge base repository 105 stores data for environmental elements 140 and a group of users 142 to maintain profiles.

The augmented intelligence engine 120 includes a resource management module 122 for collecting digital activity. The augmented intelligence engine 120 can include other interfaces 124 to connect with online sources, cloud services, search sources, device interfaces, etc. For example, a global positioning system (GPS) device of the phone may be used to locate the device of the user and report location data. This may also be done by other means, such as Wi-Fi, Bluetooth or other wireless communication standards or methods.

As discussed, the augmented intelligence engine 120 can include one or more application program interfaces (API) and interfaces to connect via networks to the various sources. Device or account identification for a registered user can be stored in the knowledge base repository 105. For example, an audio API can provide audio transcription services. In another example, an identity service API can provide name normalization method that returns a likelihood that data (e.g., disposable email addresses) is associated with a particular profile. A location API can perform Location Normalization and Location Enrichment for providing details based on location name detail descriptions.

Stakeholders can input data related to their needs and/or skills, as well as data enough to make it feasible to make/receive a firm offer used to establish relationship between users and system. The augmented intelligence engine 120 can use profiles and access multiple external systems (e.g., social networking services, building services, calendaring systems, building control systems, manufacturing equipment, etc.) to gather behavioral data. For example, the augmented intelligence engine 120 may access external systems or service to conduct search queries automatically on behalf of the user for data related to the target request of value chain. APIs may connect to each online source for collecting digital activity continuously or intermittently.

The augmented intelligence engine 120 can connect to various digital sources in order to perform real-time intelligent searching by combining identifiers from various sources, generate robust search queries, validate the search results based on user data, and determine user centric search results for environmental elements 140 and the group of users 142. The augmented intelligence engine 120 can receive a request for information about a target individual from a user of an artificial intelligence platform, analyze the digital activity of the requesting user to determine behavioral patterns associated with the request.

The behavior module 126, the deep learning module 128, and the Interaction module 134 can use the knowledge base repository 105 to organize data and generate recommendation options. The augmented intelligence engine 120 makes use of data imputed directly by the users for the creation of the, so called, primary relationships and, from the use of artificial intelligence, more specifically of deep learning, for the prediction of adjacent relationships based on the traces and abstract ecosystem preferences, as well as the indication of possible adjacent, programmed relationships. The augmented intelligence engine 120 fosters balanced entity relationships, using the Interaction module 134 including a HCI tool to reduce the information asymmetry.

Behavior module 126 can be used to let the users know which would be the best alternatives considering his/her behavior and profile. In an example, when allocating employees of an organization to move items around a factory, the augmented intelligence engine 120 can help eliminate unnecessary movement or assignment of duties if organized information is leverage to assign employs that are closer to the items. Also employers can quickly locate employees nearby if they can have better information. Consequently, the parties could save time and money, improving the result of relationships.

The behavior module 126 and the deep learning module 128 organizing data to understand the needs of each kind of relationship as well as the specific skills and/or personal profile of people involved, information is ranked according to specific needs to fulfill the desire of the parties. In a training example, transactions are based on the data offered by the user, like the location and characteristics of the real estate, skills of the worker and so on, because of the feedbacks sent by both parties. The behavior module 126 and the deep learning module 128 learns and improves answers each time, promoting a deeper comprehension of needs (e.g., explicitly required) and possibilities (e.g., tacit desired).

The augmented intelligence engine 120 synthesizing information from the knowledge base repository 105. Such huge amount of data generates information sometimes difficult to humans understand but the system can synthesize it, analyzing different profiles, needs and behaviors, making possible a better comprehension and turning feasible take decisions regarding ways of interaction and promoting pleasant and profitable encounters. According to an example implementation, a ranking model can be generated by synthesizing the profiles to determine a feasibility factor for the service or request.

The deep learning module 128 determines the needs of different types of relationship. In a disruptive system, central values are the offer of autonomy to the complementary parts (e.g., the system's customers, providers, contractors, etc.). The needs of different types of relationship as well as skills and/or personal profile of people involved, is ranked according to specific needs to fulfill the desire of the parties. Data imputed directly by the users can be used to establish primary relationships.

Adjacent relationships can be divided into several different categories like related or complimentary services, product needs, related to the activity hired or the party's desires, from which the system is aware through different interactions with other environments or relationships. Adjacent relationships can be based on primary relationships and traces or clues left by users during ecosystem utilization. A direct adjacent relationship can be preprogrammed on the platform to take tacit advantage of explicit use from the moment of zero use by the party.

In an example a user who owns a swimming pool at home (information that is introduced at the time of registering the property), necessarily needs periodic cleaning maintenance in the same, which means the system can offer the services of a skilled professional to such user and/or suggest to that professional to offer special conditions to that user who lives nearby his other traditional customers. Another user who owns a garden at home (information that is introduced at the moment of property's registration), depending on the area inputted may need help for periodic maintenance or would be interested in equipment for hobbyist gardeners.

The augmented intelligence engine 120 identifies tacit needs from relationships between users (need for contracting services), offering the possibility of a mutual interest relationship. For a more assertive indication, from the intense use of the platform by the parties, the system, besides predicting the preprogrammed need, suggests the professional that best fits the profile of the contractor, based on his preferences, got from the abstraction of his interactions with the platform. For example, another user can be prompted for feedback on the request or to indicate availability, thresholds, or limits for one or more resource parameters associated with a request.

In another implementation a preprogrammed product acquisition relationship, can involve the user who owns a pool, in addition to the need for a professional to clean it, will also likely need, at some point, products used for cleaning the swimming pool. At this point sponsor's products can be offered upon a very accurate base.

Through the use of artificial intelligence, deep learning module 128 predictions of “adjacent relationships” are determined based on traces and abstract ecosystem preferences, as well as the indication of possible adjacent, programmed relationships. For example, relationship curation can be done by algorithms that evaluate registered results and other aspects, some of them apparently non-related, such as geographic positioning, weather forecasts, neighborhood, family structure, likes and dislikes, suitability to the proposed task, experiences, skills and antecedents, but without personal direct management. Each new interaction between the parties works as an input source for the system to organize and “learn again”, looping back endlessly.

Further, the Interaction module 134 to reduce the information asymmetry by prompting users 142 for input data, evaluation data, feedback, etc. to reduce information asymmetry For example, to organize the kid's room, the interaction module 134 can output “Hey, we know you are the best and that's exactly the kind of person we are looking for. Straight to the point, would you willing to move to the other side of the country and join us?” The synthesized data is used to match offer and demand by analyzing different reactions and feedbacks from each individual, comparing to uncountable other profiles, generating information to indicate the best alternative to fulfill a specific need, considering a wide range of possibilities.

The Interaction module 134 works with the deep learning module 128 to identify efficient or less costly options. Increasingly fed by tacit knowledge learned by the interactions, the augmented intelligence engine 120 develops a library of alternative options, validates whether possible options partially will fully comply with the demand or needs of the request, and selects one or more alternatives options.

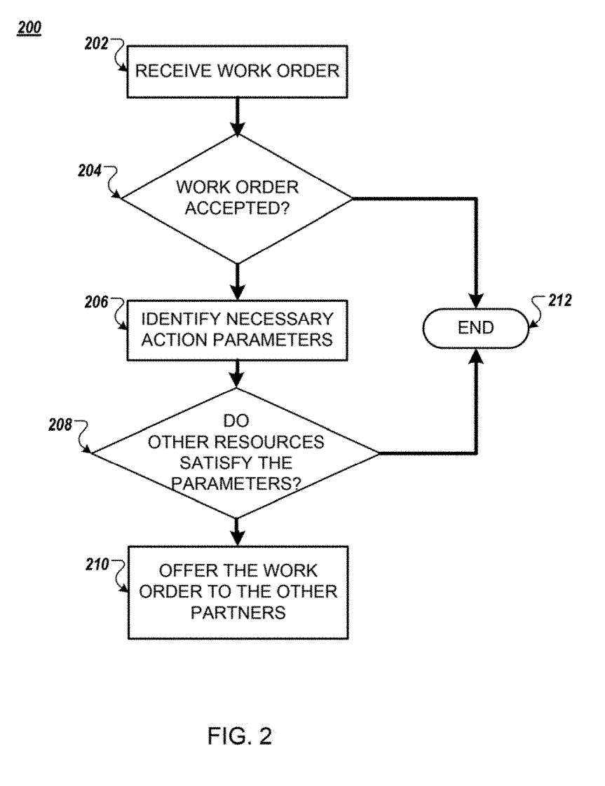

FIG. 2 a flow diagram of an example work order process 200 in accordance with one or more implementations of the present disclosure. In an example implementation, a method can be performed by processing logic that can comprise hardware (e.g., circuitry, dedicated logic, programmable logic, microcode, etc.), software (e.g., instructions run on a processing device), or a combination thereof. In an implementation, the method is performed by an augmented intelligence process (e.g., augmented intelligence engine 120 of FIG. 1) executed by a processing device. The augmented intelligence process can be a cloud service in communication with users via other online communication platforms (e.g., artificial intelligent platforms, mobile device applications, websites, messaging services, location services, inventory services, pricing tools, payment processing platforms, etc.).

The example work order process 200 provides alternatives with an intervening of HCI. Lost opportunities and associated needless costs are avoided or eliminated for the stakeholders resulting in improvements to the value chain, margins and comparative advantages with minimal processing costs.

In an example, using the work order process 200, an unemployed or underemployed carpenter in a neighborhood may receive a message notifying him of an opportunity to increase his workload by 3 times if he had the expertise (e.g., skills) for carpentry of old-style furniture, prompt the carpenter to confirm whether he has old-style furniture skills or experience, identify classes being offered for free by a school and recommend options for the carpenter to gain the skill and take on the work orders.

According to an example implementation, the augmented intelligence engine 120:

a. organizes the input data according to the needs of each kind of relationship as well as the specific skills and/or personal profile of people involved

b. Information generated from the input data is then ranked according to the specific needs.

c. learns by interactions to automatically select and indicates the best choices from a wide range of alternatives which more likely will comply with the demand.

d. synthesizes information by analyzing different profiles, needs and behaviors, allowing feasibility in taking decisions.

e. implements HCl/Augmented Intelligence to reduce information asymmetry, so that the users know which would be the best alternative considering his/her behavior and profile.

f. analyses the whole activity's value chain instead of just considering the relationship hired thus acting to unlock the value in each of the possible interactions related to the stream.

At block 202, the processing device receives a work order. At block 204, the processing device determines whether the work order is accepted. At block 206, the processing device identifies necessary action parameters. At block 208, the processing device determines whether other resources satisfy the action parameters. At block 210, the processing device offers the work order to other partners for feedback. The work order can be assigned to the other partners if they determine they have whether resources to satisfy the action parameters.

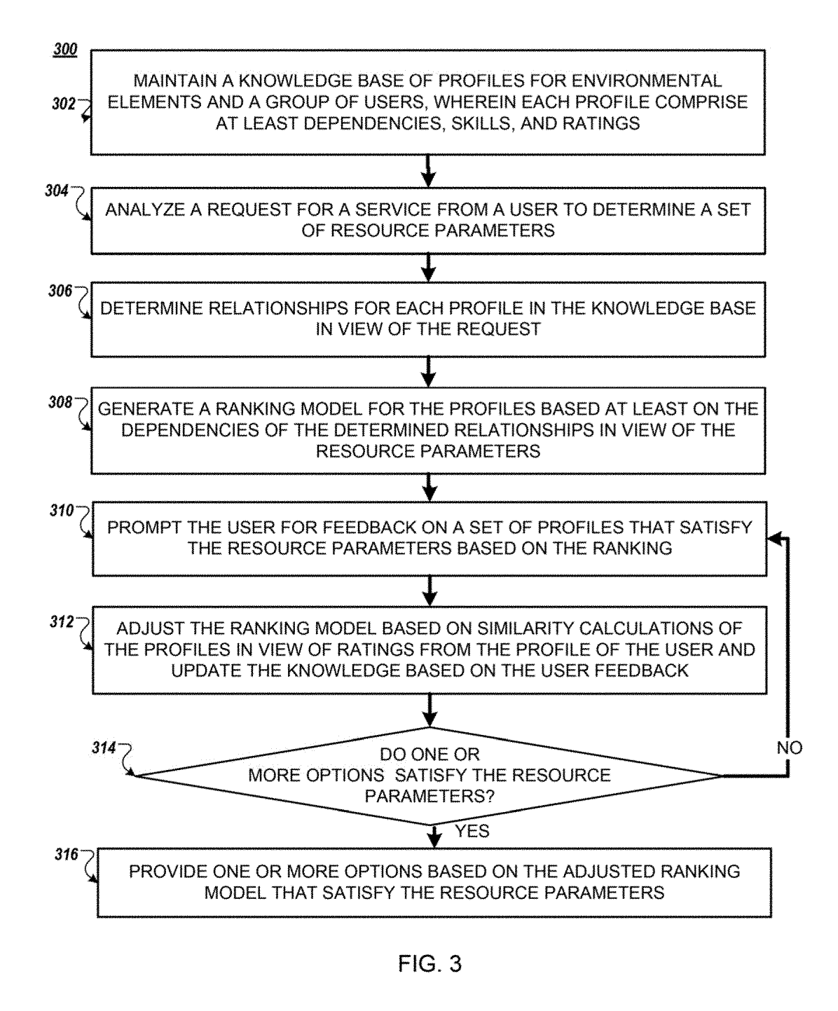

FIG. 3 is a flow diagram of an example of augmented intelligence allocation process in accordance with one or more implementations of the present disclosure. At block 302, the processing device maintains a knowledge base of profiles for environmental elements and a group of users, wherein each profile comprise at least dependencies, skills, and ratings. The processing device can also add individuals to the repository by generating new records.

At block 304, the processing device analyzes a request for a service (e.g., a work order) from a user to determine a set of resource parameters. At block 306, the processing device determines determine relationships for each profile in the knowledge base in view of the request. At block 308, the processing device generates a ranking model for the profiles based at least on the dependencies of the determined relationships in view of the resource parameters.

At block 310, the processing device prompts the user for feedback on a set of profiles that satisfy the resource parameters based on the ranking. At block 312, the processing device adjusts the ranking model based on similarity calculations of the profiles in view of ratings from the profile of the user. For example, adjust the ranking model can be a weighting. At block 314, the processing device updates the knowledge based on the user feedback. At block 316, the processing device provides one or more options based on the adjusted ranking model that satisfy the resource parameters.

Data sources (other than user input) are used by the system to acquire or identify the specific skills and/or personal profile of people involved. In addition to the inputs reported by the user, the system identifies possible helpful adjacent relationships as follows:

1. Through the similarity of the set of skills of the users in the system: A simplified example of this is: if a user “x” has the skills s1, s2, s3 and s4 and another user “y” with the skills s1, s2 and s3, he may be able to perform tasks that require skill s4 because his profile are similar to that of user x. Bringing for a concrete example, a user “x” has as skills to lay brick, to lay floor, to grout floor, to tow wall and a user y has the skills to lay brick, to lay floor and to tow wall. Although user y does not explicitly declare that grout floor, as it has skills very similar to user x, and user x grout floor, the system suggests that the user y can meet a demand for the grouting floor skill.

2. By similarity calculated based on points of interest. The system tracks users through cell phone GPS. Based on the positions provided by the mobile phone, we identify the stops points made by users in different types of commerce, for example. Based on these habits calculates the similarity among users. Based on this similarity, it suggests providers that have satisfactorily serviced other contractors with the same user profile.

3. Inferences from input keywords. The system allows each service provision be evaluated with a score and a text with a description of the service provided. It is based on deep learning to, based on the grades and texts of the evaluations, to link keywords to each user. There may be no defined keywords. Based on the text written by the users the system keeps a dictionary of the words already used and learns new words as they are inserted. These can be, for example, speed, punctuality, duration of service, etc.

4. Dynamic evaluation of ambience. Each user evaluates the aspects of each service provision in a personal way. The system “understands” such peculiarities and manages to suggest professionals who have already performed services with these aspects for other users. For example, if a user contracts customarily services during a certain period of the day, the system will only indicate adjacent relationships in the period in which the user is more likely to receive an offer. Weather and traffic data may also be used to, for example, not suggest a service provider who usually moves by bicycle to the workplaces to a contractor who owns an property that will receive the services in an area where it is inaccessible by bicycle.

The system changes the rankings based on different user input. All information, whether explicit or tacit, are input to the system, which can constantly or responsively update the ranking information in each new interaction related to the parties. The use of deep learning and its training techniques, such as backpropagation, allow the system to be infinitely changeable, improving its indexes of success with each new iteration of learning.

In an example implementation, all node ranking is dynamic and orderly in a one-to-one, personal and non-transferable way, for each user. Preference generally means “to carry on, put first”. Each node can have its own preference. That is, it establishes its personal ranking, which requires the system to establish a dynamic and individual ranking in order to meet these preferences.

Examples of dynamic rankings: Based on direct information: A particular provider X who previously resided within 500 meters of a contractor Y now resides more than 5 kilometers (km) from the contractor, thus, the ranking in the indication of the provider X to the contractor Y becomes less relevant, since the total displacement between the parties has a weight in the training of the learning network, thus distancing the indication of the provider X to the contractor Y.

Based on tacit information: A contractor X evaluates his services providers, indicating that he valorizes the punctuality of the professionals, so a professional Y who usually arrives late at service, even residing 1 km away the contractor's residence has a worse ranking than a professional Z, that although living 1,2 km away of the X contractor's residence, who has the punctuality among the strengths, since the satisfaction of the users and the assertiveness of the indications weights more than the distance itself.

Detailed description of the “information” that is being ranked and/or the ranking algorithm. The system can include two components, a ranking of models using deep learning and the other with collaborative filter. For the use of deep learning, all data collected on the platform are used for network training. The ranking that uses the collaborative filter concept is created based on the system users' ratings on their workers to recommend these workers to other users. Users who have great similarity of preferences are considered “neighbors.” In this way, a user will receive recommendations from preferences inferred from the relations of other users who are his “neighbors”. Thus, neighboring users produce their prediction of recommending a particular worker to other users.

The degree of similarity between users “u” and “n” is computed by Pearson's correlation of the evaluations performed by both, represented here by the userSim (u, n) function, which is used to weight the influence of user evaluation “n” in the prediction to a particular worker “i” for user “u”.

The userSim(x,y) function, Pearson's correlation, for the users x and y who evaluated the set of workers I_{xy} with rating rₓᵢ and r_{yi}, mean r̅ₓᵢe r̅_{yi}, can be defined as follows:

$$userSim ( x , y ) = \frac{{\sum }_{ieIxy} ( {r}_{xi} - {\overline{r}}_{x} ) \cdot ( {r}_{yi} - {\overline{r}}_{y} )}{\sqrt{{\sum }_{ieIxy} {( {r}_{xi} - {\overline{r}}_{x} )}^{2}} \cdot \sqrt{{\sum }_{ieIxy} {( {r}_{yi} - {\overline{r}}_{y} )}^{2}}}$$

The algorithm can be described as: given user group “N”, which has high similarity with a user “u”, are said neighbors. If “i” is any worker, with evaluations performed by neighboring user group “N”, in the average of evaluations of a user “n”, we can predict the evaluation of “u” for provider “i” of following form:

$$rank ( u , i ) = \frac{{\sum }_{n ∈ N} userSim ( u , n ) \cdot ( {r}_{ni} - {\overline{r}}_{n} )}{{\sum }_{n ∈ N} userSim ( u , n )}$$

Both rank systems are models can be implemented in python™ and use of TensorFlow™ or other software libraries for dataflow programming across a range of tasks.

Ranking of party's needs and desires are ranked. Conflict resolution: Needs or desires are possible services to be served by users of the platform or products related to it. The best ranked services, professionals or products are suggested. As the suggestions are handled separately, to each user, there is no treatment for conflicts. The system can automatically select and indicates alternatives from options a wide range of alternatives which more likely will fully comply with the demand.

Steps to select and indicate options; Determining which options are alternatives; options library. A first example implementation is the traditional way, when the user explicitly searches for what he needs. A second example implementation is when the system, based on the models created and trained, can suggest possible services that a given user will need, based on his (and his “neighbors”) interaction with the system. Whether through hiring, searching or providing services to other users. There are libraries of options, for example only products and services that are already registered are recommended by the system.

Calculating the likelihood of each alternative to fully comply with the demand: the system uses the ranking and deep learning tools as described above. It is, indeed deeper than persons commonly realize, while registers and analyses different reactions and feedbacks from each individual, comparing to uncountable other profiles, generating information enough to indicate the best alternative to fulfill a specific need, considering a wide range of possibilities.

Comparing user behavior and feedback to other profiles: User behavior in the system can be mapped and used as input for neural network training. In this way, we are able to understand and perform the analysis of users' feelings, using deep learning techniques, which has its increased accuracy with each new interaction, be it an evaluation, interaction with the system or its daily displacement pattern, obtained through the coordinates sent by the system installed on his mobile device. This information is added to the neural network training sets (deep learning) for the readjustment of the weights using backpropagation algorithms.

All user behavior can be mapped as input is associated with its relationships in the platform, so the adjustment of network weights represents the relationship of user behavior using the system with other service providers' users.

Referring to other profiles or another data source: In addition to analyzing user profiles, the model allows the insertion of other types of data, such as information about partners who are interested in promoting products using the platform, Internet browsing pattern (identification of wishes),consumption pattern and/or displacement (both internal and external sources achieved from partnerships with other big data companies), topics of interest or that are not user pleasure and therefore promoted or avoided. In this example, in addition to suggesting profiles of other users, the system is able to identify interests that are outside the platform.

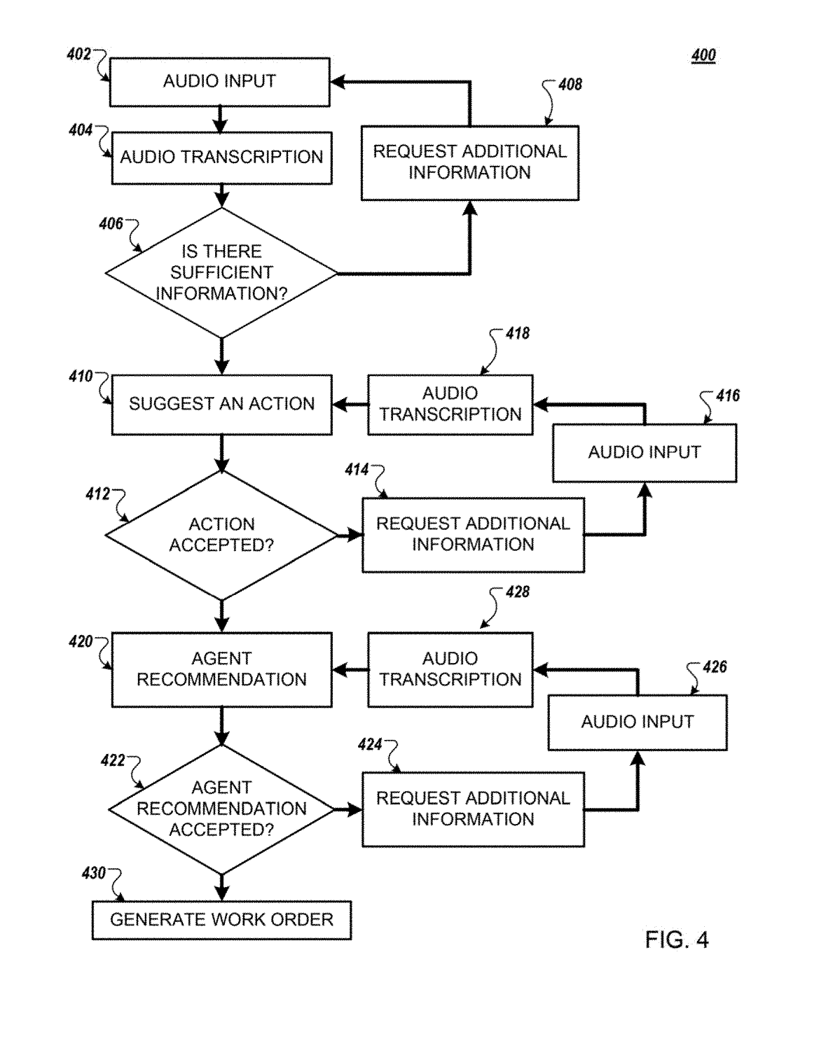

FIG. 4 is a flow diagram of an example request input process 400 in accordance with one or more implementations of the present disclosure. As discussed, the augmented intelligence engine can include one or more application program interfaces (API) and interfaces to connect via networks to the various sources. Device or account identification for a registered user can be stored in the knowledge base repository. For example, an audio API can provide audio transcription services. In another example, an identity service API can provide name normalization method that returns a likelihood that data (e.g., disposable email addresses) is associated with a particular profile. A location API can perform Location Normalization and Location Enrichment for providing details based on location name detail descriptions.

In an example implementation, the processing module can use audio information At 402, the system receives audio input and generates a text based transcription of the received audio at 404. At 406, the system determines if there is sufficient information to process the request. The augmented intelligence system can use an interactive process via a HCI to request additional information from a user or system at 408. If the additional information is audio, the system can repeat steps 404, 406, and 408 to repeat processing the audio.

At 410, the system can suggest an action as described above in reference to FIGS. 1-3. At 412, the interactive process can prompt the user for feedback or acceptance of the suggested action plan. In response to the user rejecting the suggested action at 412, the system can request additional information at 414, receive audio input at 416 and output another audio transcript at 418.

In response to the user feedback or acceptance rejecting the suggested action plan, a suggestion of an agent to carry out the action can be provided at 420. For example, the agent suggestion can be formulated according to the affinity between the parties.

At 422, the interactive process can prompt the user for feedback or acceptance of the agent suggestion. If additional information is needed at 424, additional audio input can be received at 426, and processed into text via transcript at 426. If the agent suggestion is accepted at 422, the system can generate a work order at 426.

According to an example aspect, the system can offer a high-level training course to the person: An example of a real output is that which will be delivered to the users as soon as the offer of such course is registered.

The system can detects the complaints of a number of users, regarding to one service, identifies the need of a training course to fulfill such need, and informs the lack of such skill among the users to users registered as coaches/teachers. As soon as the course starts to be offered and registered at the platform, the likely interested users are informed, indicating the likely increase job proposals (and earnings) if the user decide to apply to such course.

Some surface level characteristics can be considered similar or comparable to advertising. At a surface or user level, it can be compared to advertising because at the end, a product/service is being offered to a potential customer but the prior steps are not known by the users nor pinpointed by a person, meaning that such product is fully identified by artificial intelligence. The system supports payment processing services including Bitcoin.

Further, high-level training courses fit into the system. As all the interaction performed by the parties is used for network training, the evaluations, divided into personal and professional categories, are important sources of input data for feeding the prediction system. The offer of products as a high level course for users of the ecosystem can be both direct and standard, being offered to professionals who explicitly inform that they do not have training in their area of work; As well as can be predictive based on the evaluations received by the professional, where the contracting users evaluate a certain provider and declare that the professional has medium knowledge in its area of work, so the system offers the course to the certain professional, according to the direct evaluations (objective) or abstracts this information from the typed words (descriptive text), as a result of the work of the deep learning network.

This same example serves as analogy to the use of the prediction system and the direct recommendation based on evaluations to suggest to a provider to be nicer during the provision of services. That is, from direct or inferred inputs from the use of the network are recommended products, services or any action, which become more assertive with each new interaction of users with the ecosystem. Although there is similarity to the final action, which that is of recommendation, and can be easily attributed to advertising, before recommending any product, service or action, the platform identifies its need and directs it to users who are possibly interested in supplying it. The process generates assertive demands and responses, significantly decreasing the required investment by partners (and thus releasing value in the chain), unlike standard advertising techniques, where the return on advertising actions are proportional to their costs.

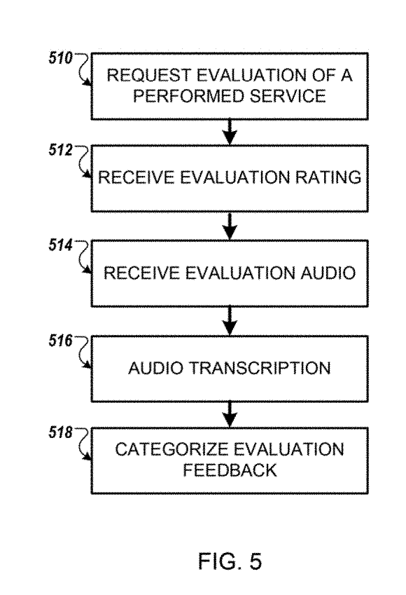

FIG. 5 a flow diagram of an example evaluation process 500 in accordance with one or more implementations of the present disclosure. At 510, the system requests evaluation of a preformed service and receives the user's evaluation rating at 512. The system can receive evaluation data in audio format at 514 and generate an audio transcription at 516. At 518, the categorizes the evaluation feedback to process the request and updates the user profile in the knowledge base with new behavior information including at least the rating.

The flow of product and service indications of each partner is terminated at the moment of the user's redirection to the partner platform through the callback informed to receive the traffic of the requests and the indication counted in our billing system for later accounting of the contract. The deep learning model uses the full textual detailed description of the product or service to understand it and be able to relate it to the user's demands. In addition, the model is initially trained with a set of textual descriptions of products and services that knowingly meet one or several possible demands and that from its use and constant training, it is able to associate a textual set (product or service description), to the demands of the users. In this way, the model has the ability to interpret previously unknown products and services on the platform, to the users' demands, whether direct or tacit.

It is also worth remembering that a suggestion (product description+positive or negative user feedback) made at time t (today) is used to train the model and will influence a suggestion at time t+1, t+2, . . . , t+n (future). In this way the model remains in constant learning and is also able to generalize the temporal tendencies associated with the description of the product or service.

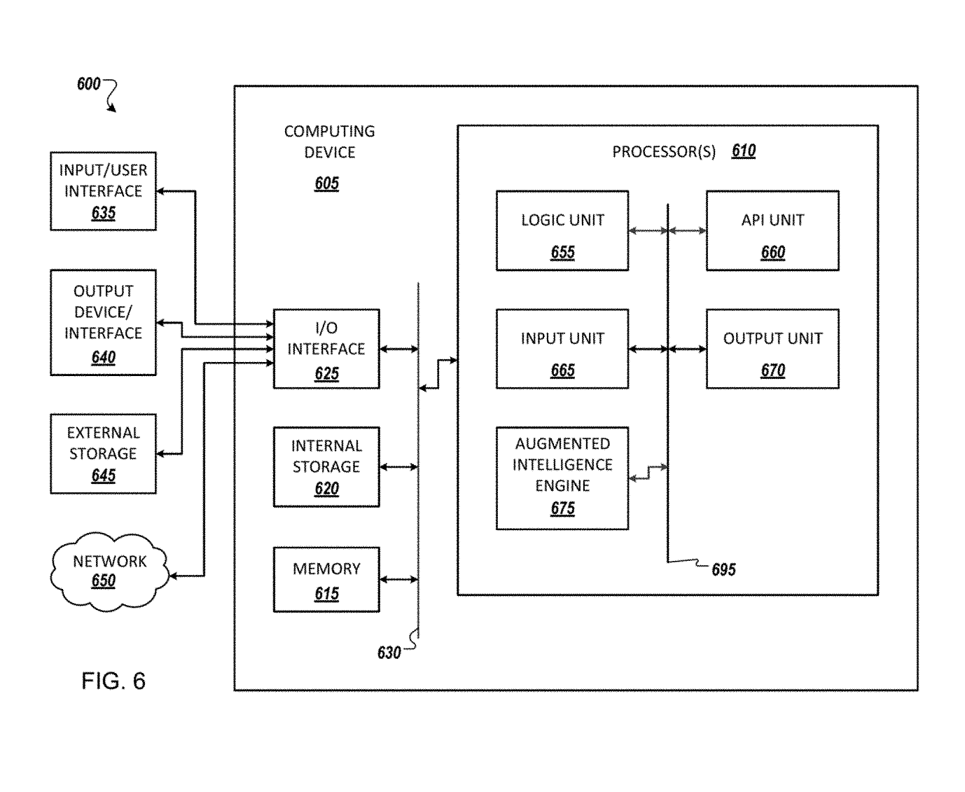

FIG. 6 illustrates an example computing environment 600 with an example computer device 605 suitable for use in some example implementations. Computing device 605 in computing environment 600 can include one or more processing units, cores, or processors 610, memory 615 (e.g., RAM, ROM, and/or the like), internal storage 620 (e.g., magnetic, optical, solid state storage, and/or organic), and/or I/O interface 625, any of which can be coupled on a communication mechanism or bus 630 for communicating information or embedded in the computing device 605.

Computing device 605 can be communicatively coupled to input/user interface 635 and output device/interface 640. Either one or both of input/user interface 635 and output device/interface 640 can be a wired or wireless interface and can be detachable. Input/user interface 635 may include any device, component, sensor, or interface, physical or virtual, which can be used to provide input (e.g., buttons, touch-screen interface, keyboard, a pointing/cursor control, microphone, camera, braille, motion sensor, optical reader, and/or the like). Output device/interface 640 may include a display, television, monitor, printer, speaker, braille, or the like. In some example implementations, input/user interface 635 and output device/interface 640 can be embedded with or physically coupled to the computing device 605. In other example implementations, other computing devices may function as or provide the functions of input/user interface 635 and output device/interface 640 for a computing device 605.

Examples of computing device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 605 can be communicatively coupled (e.g., via I/O interface 625) to external storage 645 and network 650 for communicating with any number of networked components, devices, and systems, including one or more computing devices of the same or different configuration. Computing device 605 or any connected computing device can be functioning as, providing services of, or referred to as a server, client, thin server, general machine, augmented intelligence process -purpose machine, or another label.

I/O interface 625 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computing device 605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 655, application programming interface (API) unit 660, input unit 665, output unit 670, augmented intelligence engine 675, information transmitting unit 690, and inter-unit communication mechanism 695 for the different units to communicate with each other, with the OS, and with other applications (not shown). For example, augmented intelligence engine 675, information transmitting unit 690 may implement one or more processes shown in FIGS. 5-8. The described units and elements can be varied in design, function, configuration, or implementation and are not limited to the descriptions provided.

In some example implementations, when information or an execution instruction is received by API unit 660, it may be communicated to one or more other units (e.g., logic unit 655, input unit 665, output unit 670, augmented intelligence engine 675, and information transmitting unit 690). For example, when a social media post is received via the input unit 665, the augmented intelligence engine 675 may analyze the post to detect an identifier associated with a target individual. Additionally, when the augmented intelligence engine 675 collects digital activity, the output unit 670 may also send an output to a user or other service.

In some instances, the logic unit 655 may be configured to control the information flow among the units and direct the services provided by API unit 660, input unit 665, output unit 670, post detecting unit 675, and information transmitting unit 690 in some example implementations described above. For example, the flow of one or more processes or implementations may be controlled by logic unit 655 alone or in conjunction with API unit 660.

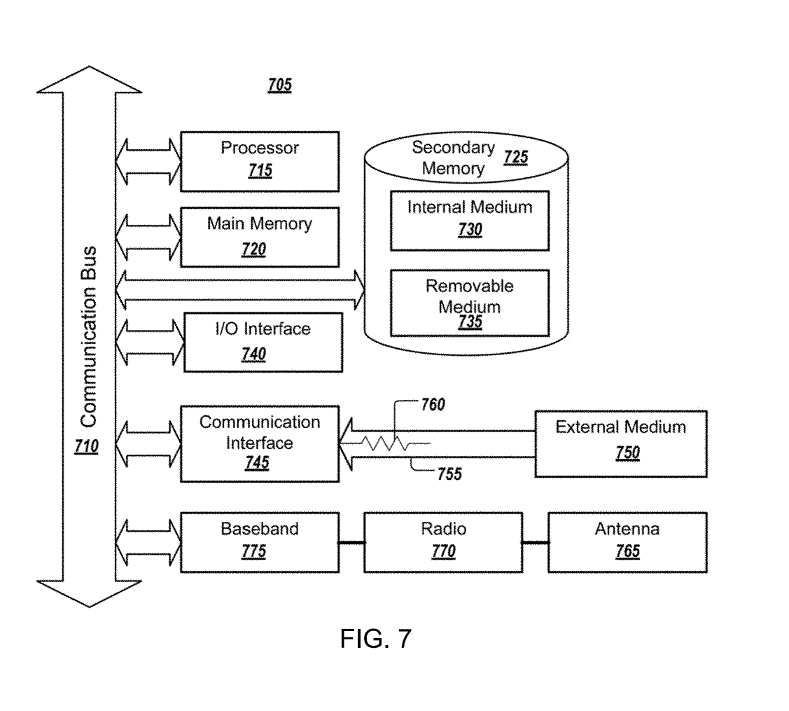

FIG. 7 provides a block diagram illustrating an example computing device or system that may be used in connection with various example implementations described herein. For example the system 705 may be used as or in conjunction with one or more of the mechanisms or processes described above, and may represent components of processors, user system(s), and/or other devices described herein. The system 705 can be a server or any conventional personal computer, or any other processor-enabled device that is capable of wired or wireless data communication. Other computer systems and/or architectures may be also used, as will be clear to those skilled in the art.

The system 705 preferably includes one or more processors, such as processor 715. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 715. Examples of processors which may be used with system 705 include, without limitation, the Pentium® processor, Core i7® processor, and Xeon® processor, all of which are available from Intel Corporation of Santa Clara, Calif.

The processor 715 is preferably connected to a communication bus 710. The communication bus 710 may include a data channel for facilitating information transfer between storage and other peripheral components of the system 700. The communication bus 710 further may provide a set of signals used for communication with the processor 715, including a data bus, address bus, and control bus (not shown). The communication bus 710 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 788 general-purpose interface bus (GPIB), IEEE 696/S-30, and the like.

System 705 preferably includes a main memory 720 and may also include a secondary memory 725. The main memory 720 provides storage of instructions and data for programs executing on the processor 715, such as one or more of the functions and/or modules discussed above. It should be understood that programs stored in the memory and executed by processor 715 may be written and/or compiled according to any suitable language, including without limitation C/C++, Java, JavaScript, Pearl, Visual Basic, .NET, and the like. The main memory 720 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 725 may optionally include an internal memory 730 and/or a removable medium 735, for example a floppy disk drive, a magnetic tape drive, a compact disc (CD) drive, a digital versatile disc (DVD) drive, other optical drive, a flash memory drive, etc. The removable medium 735 is read from and/or written to in a well-known manner. Removable storage medium 735 may be, for example, a floppy disk, magnetic tape, CD, DVD, SD card, etc.

The removable storage medium 735 is a non-transitory computer-readable medium having stored thereon computer executable code (i.e., software) and/or data. The computer software or data stored on the removable storage medium 735 is read into the system 705 for execution by the processor 715.

In alternative example implementations, secondary memory 725 may include other similar means for allowing computer programs or other data or instructions to be loaded into the system 705. Such means may include, for example, an external storage medium 750 and an interface 745. Examples of external storage medium 750 may include an external hard disk drive or an external optical drive, or and external magneto-optical drive.

Other examples of secondary memory 725 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 735 and communication interface 745, which allow software and data to be transferred from an external medium 750 to the system 705.

System 705 may include a communication interface 745. The communication interface 745 allows software and data to be transferred between system 705 and external devices (e.g. printers), networks, or information sources. For example, computer software or executable code may be transferred to system 705 from a network server via communication interface 745. Examples of communication interface 745 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 705 with a network or another computing device.

Communication interface 745 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated services digital network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 745 are generally in the form of electrical communication signals 760. These signals 760 are preferably provided to communication interface 745 via a communication channel 755. In one example implementation, the communication channel 755 may be a wired or wireless network, or any variety of other communication links. Communication channel 755 carries signals 760 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 720 and/or the secondary memory 725. Computer programs can also be received via communication interface 745 and stored in the main memory 720 and/or the secondary memory 725. Such computer programs, when executed, enable the system 705 to perform the various functions of the present invention as previously described.

In this description, the term “computer readable medium” is used to refer to any non-transitory computer readable storage media used to provide computer executable code (e.g., software and computer programs) to the system 705. Examples of these media include main memory 720, secondary memory 725 (including internal memory 730, removable medium 735, and external storage medium 750), and any peripheral device communicatively coupled with communication interface 745 (including a network information server or other network device). These non-transitory computer readable mediums are means for providing executable code, programming instructions, and software to the system 705.

In an example implementation that is implemented using software, the software may be stored on a computer readable medium and loaded into the system 705 by way of removable medium 735, I/O interface 740, or communication interface 745. In such an example implementation, the software is loaded into the system 705 in the form of electrical communication signals 760. The software, when executed by the processor 715, preferably causes the processor 715 to perform the inventive features and functions previously described herein.

In an example implementation, I/O interface 740 provides an interface between one or more components of system 705 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 705 also includes optional wireless communication components that facilitate wireless communication over a voice and over a data network. The wireless communication components comprise an antenna system 765, a radio system 770, and a baseband system 775. In the system 705, radio frequency (RF) signals are transmitted and received over the air by the antenna system 765 under the management of the radio system 770.

In one example implementation, the antenna system 765 may comprise one or more antennae and one or more multiplexors (not shown) that perform a switching function to provide the antenna system 765 with transmit and receive signal paths. In the receive path, received RF signals can be coupled from a multiplexor to a low noise amplifier (not shown) that amplifies the received RF signal and sends the amplified signal to the radio system 770.

In alternative example implementations, the radio system 770 may comprise one or more radios that are configured to communicate over various frequencies. In one example implementation, the radio system 770 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 770 to the baseband system 775.

If the received signal contains audio information, then baseband system 775 decodes the signal and converts it to an analog signal. Then the signal is amplified and sent to a speaker. The baseband system 775 also receives analog audio signals from a microphone. These analog audio signals are converted to digital signals and encoded by the baseband system 775. The baseband system 775 also codes the digital signals for transmission and generates a baseband transmit audio signal that is routed to the modulator portion of the radio system 770. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 765 where the signal is switched to the antenna port for transmission.

The baseband system 775 is also communicatively coupled with the processor 715. The central processing unit 715 has access to data storage areas 725 and 725. The central processing unit 715 is preferably configured to execute instructions (i.e., computer programs or software) that can be stored in the memory 720 or the secondary memory 725. Computer programs can also be received from the baseband processor 765 and stored in the data storage area 720 or in secondary memory 725, or executed upon receipt. Such computer programs, when executed, enable the system 705 to perform the various functions of the present invention as previously described. For example, data storage areas 720 may include various software modules (not shown).

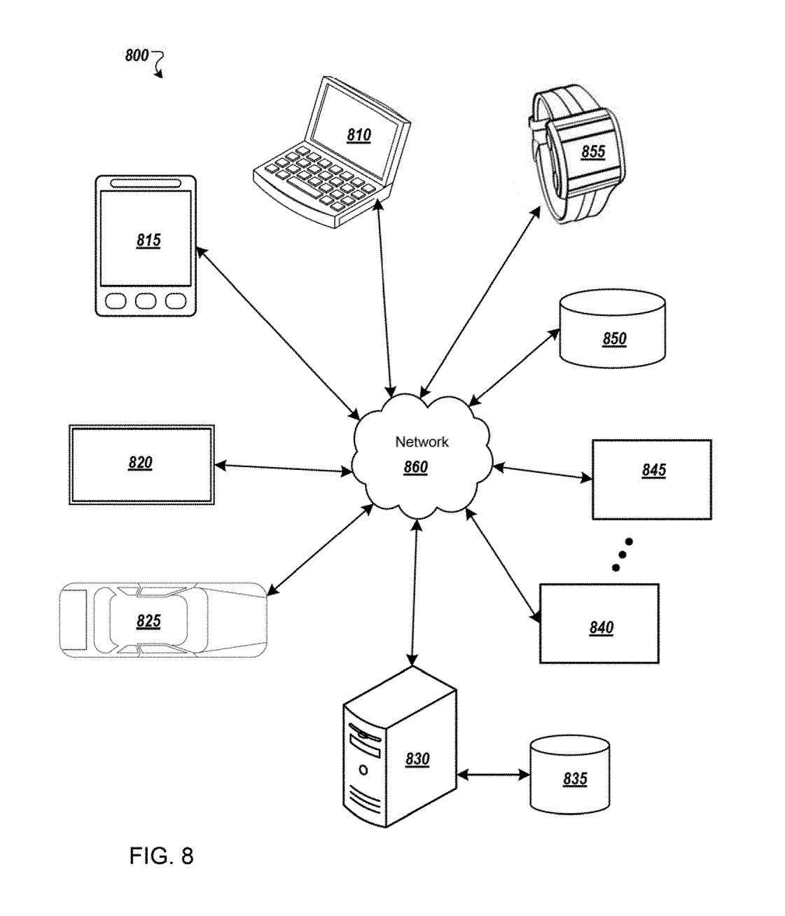

FIG. 8 shows an example environment suitable for some example implementations of the present application. Environment 800 includes devices 810-355, and each is communicatively connected to at least one other device via, for example, network 860 (e.g., by wired and/or wireless connections). Some devices may be communicatively connected to one or more storage devices 835 and 850.

An example of one or more devices 810-355 may be computing device 805 described in FIG. 7. Devices 810-355 may include, but are not limited to, a computer 810 (e.g., a laptop computing device), a mobile device 815 (e.g., smartphone or tablet), a television 820, a device associated with a vehicle 825, a server computer 830, computing devices 840-345, storage devices 835 and 850 and wearable device 855.

In some implementations, devices 810-325 and 855 may be considered user devices (e.g., devices used by users to access the augmented intelligence platform, submit requests, provide additional identifiers, and receive a digital activity report). Devices 830-350 may be devices associated with one or more other platforms or online service that interact with the augmented intelligence engine platform.

For example, a user (e.g., Alice) may access an artificial intelligence service platform, submit a request via a voice command, that is received by the augmented intelligence engine platform and receive a digital activity report using user device 810 or 815 supported by one or more devices 830-350.

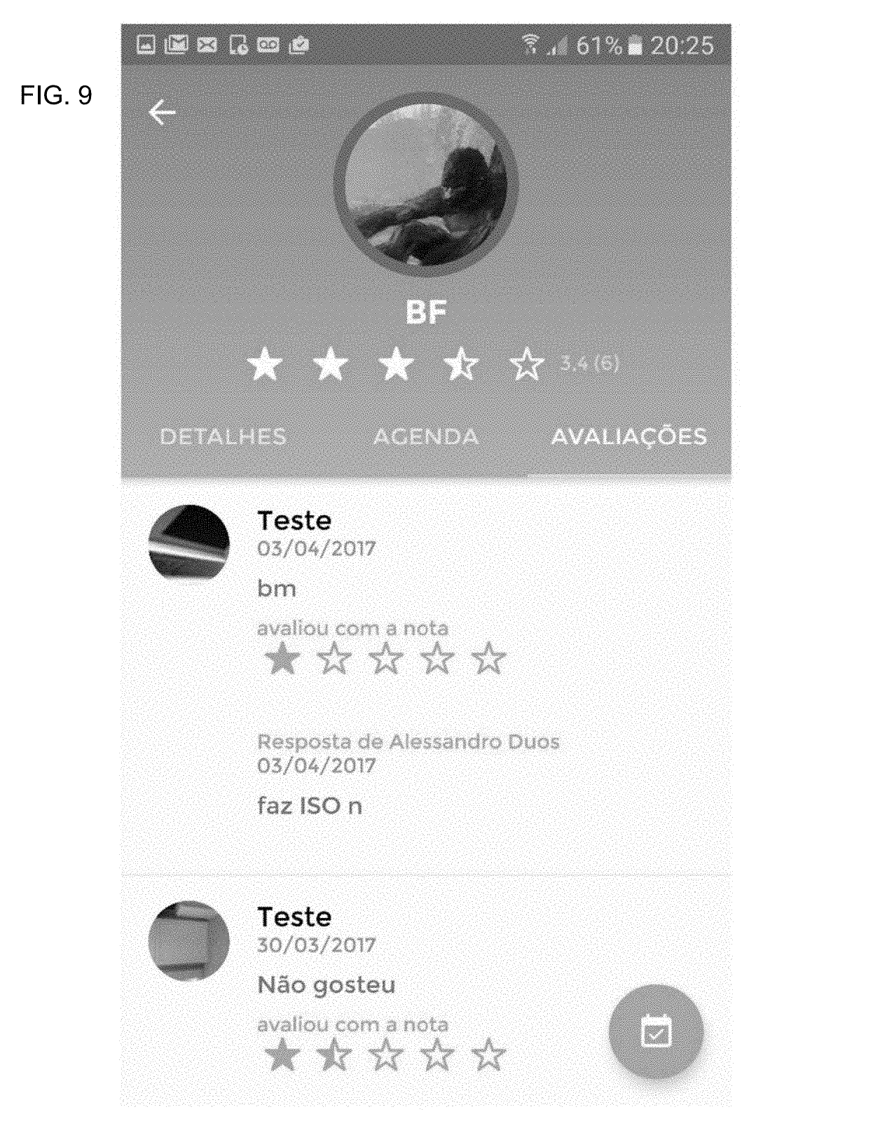

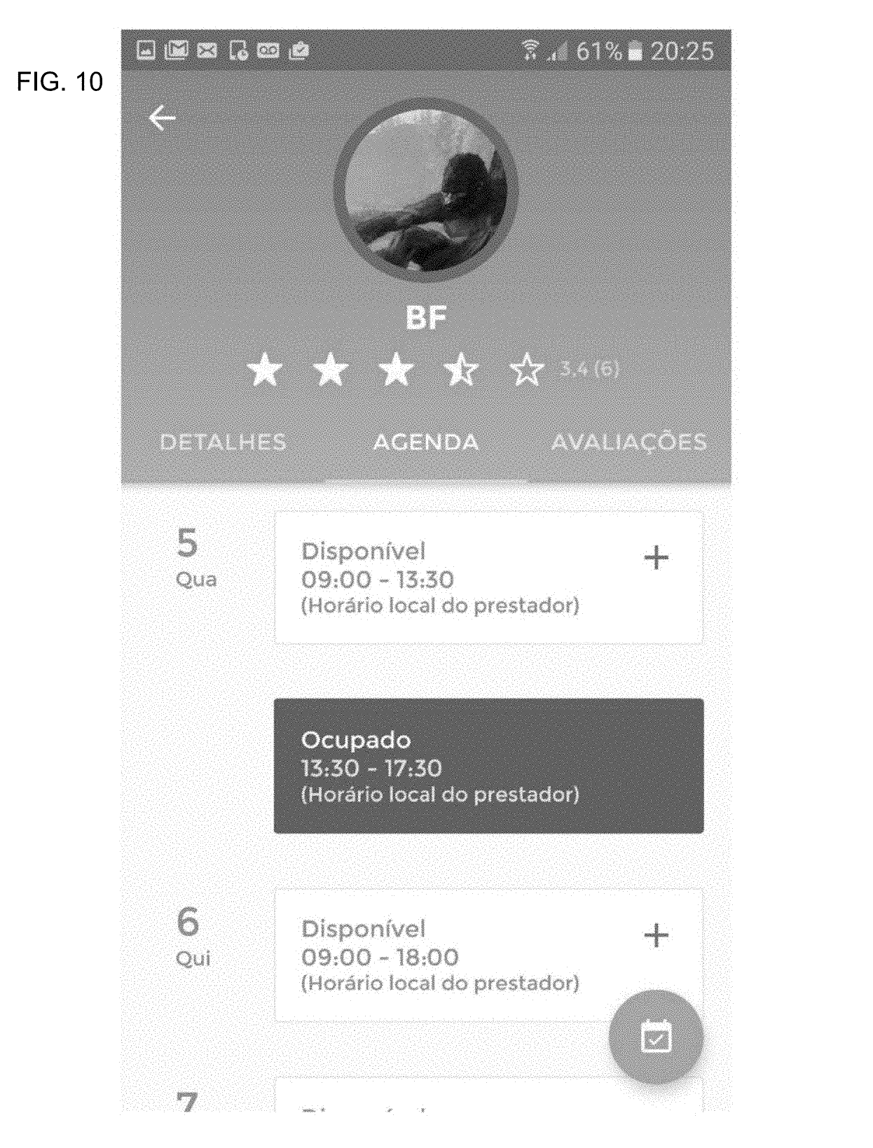

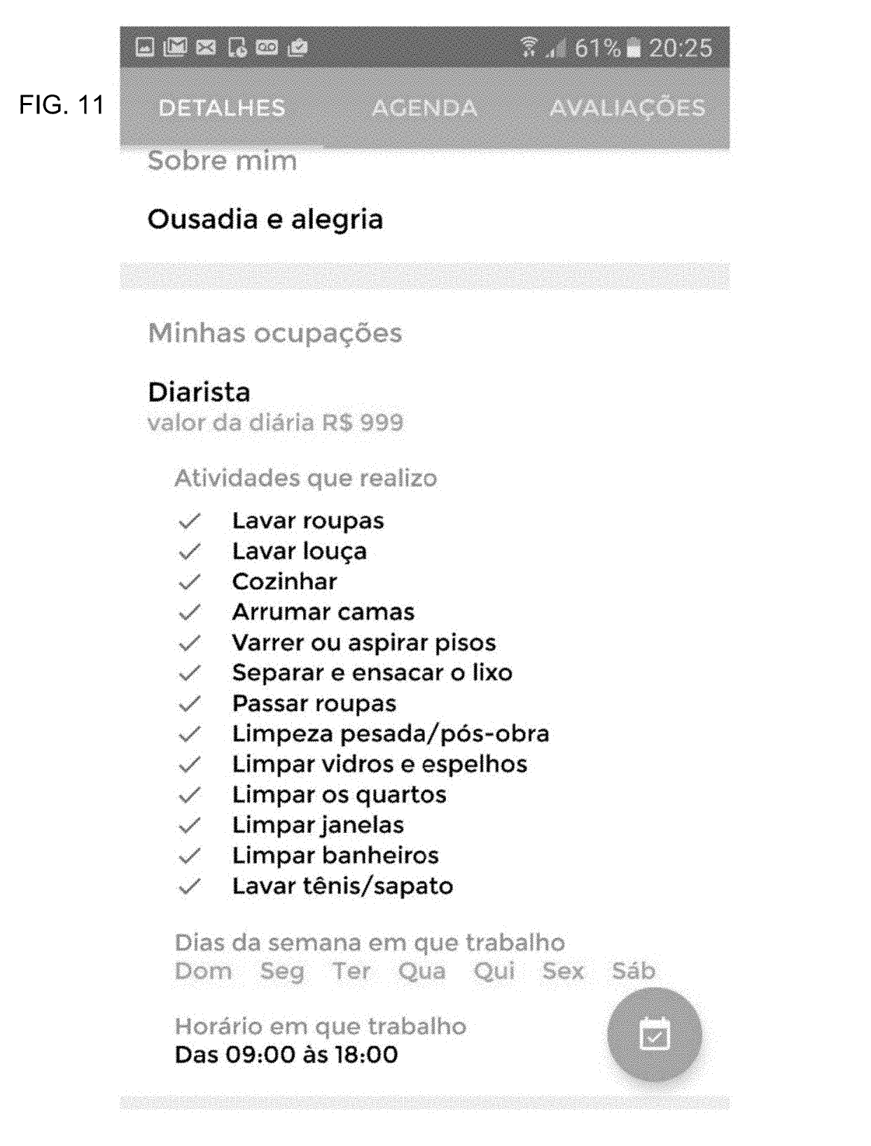

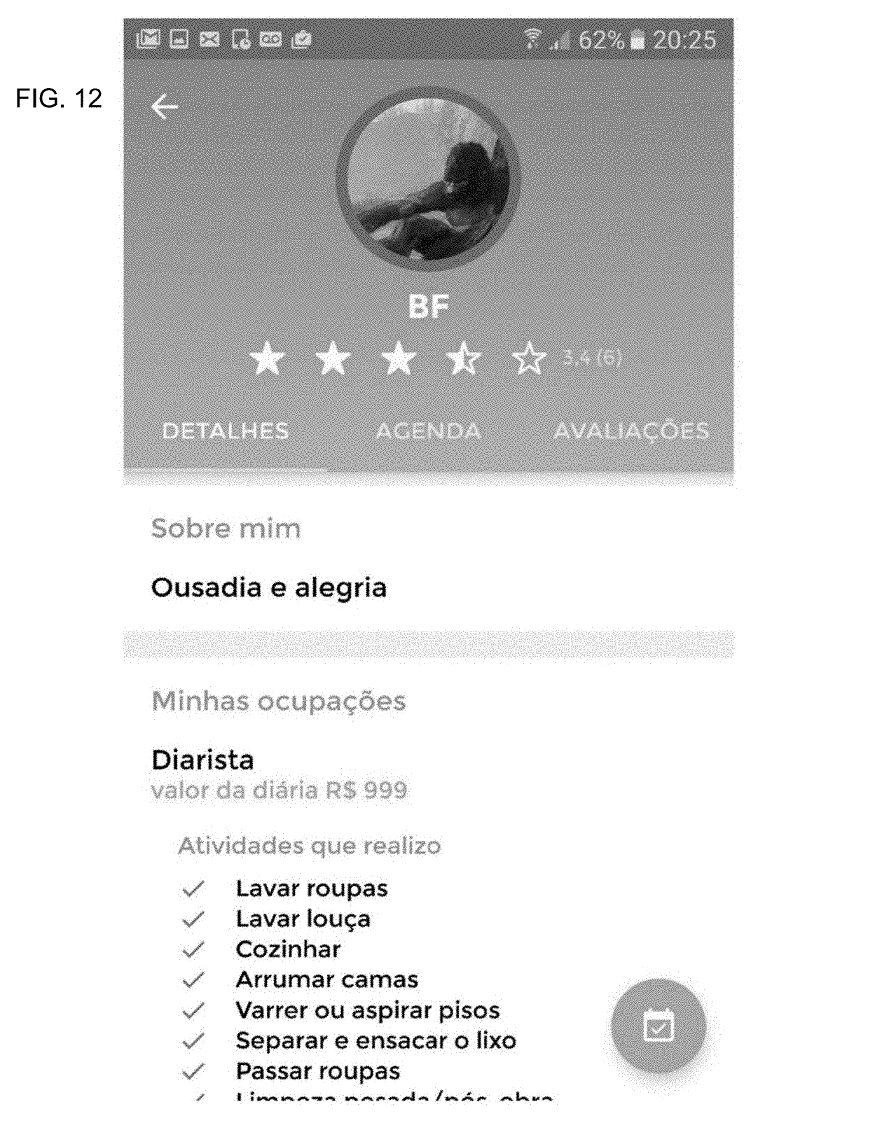

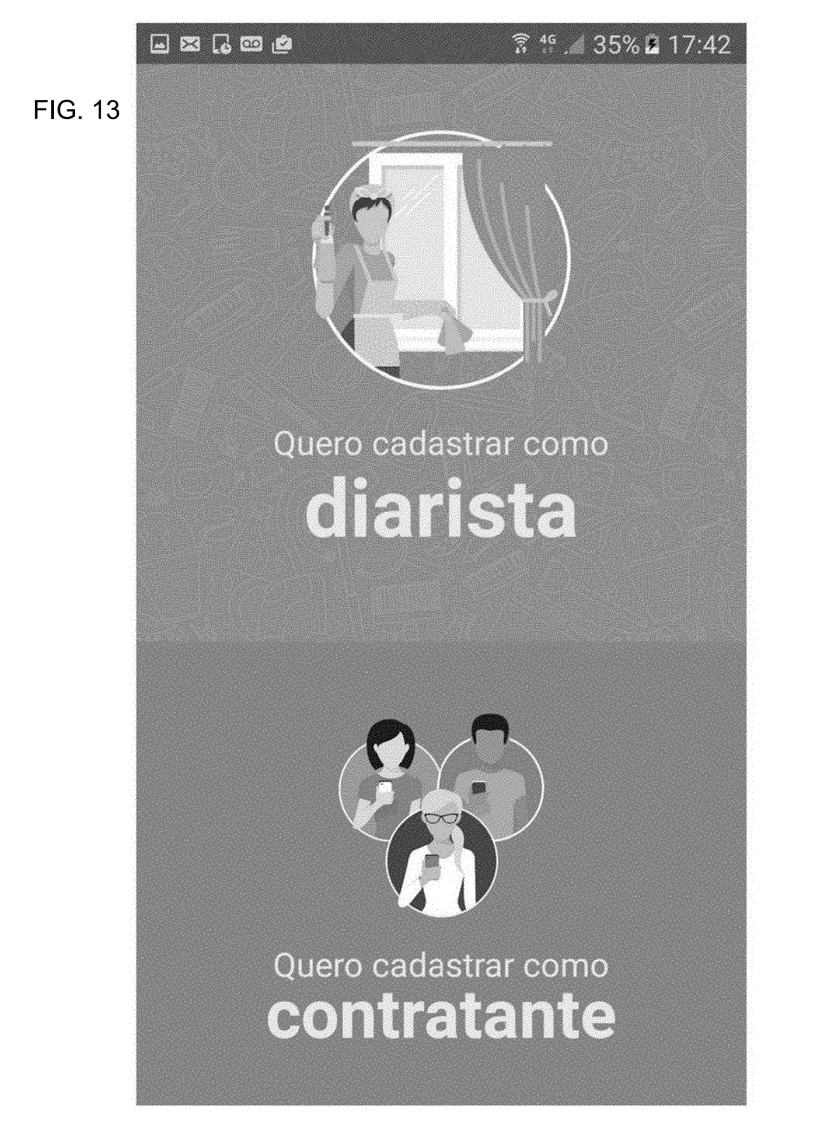

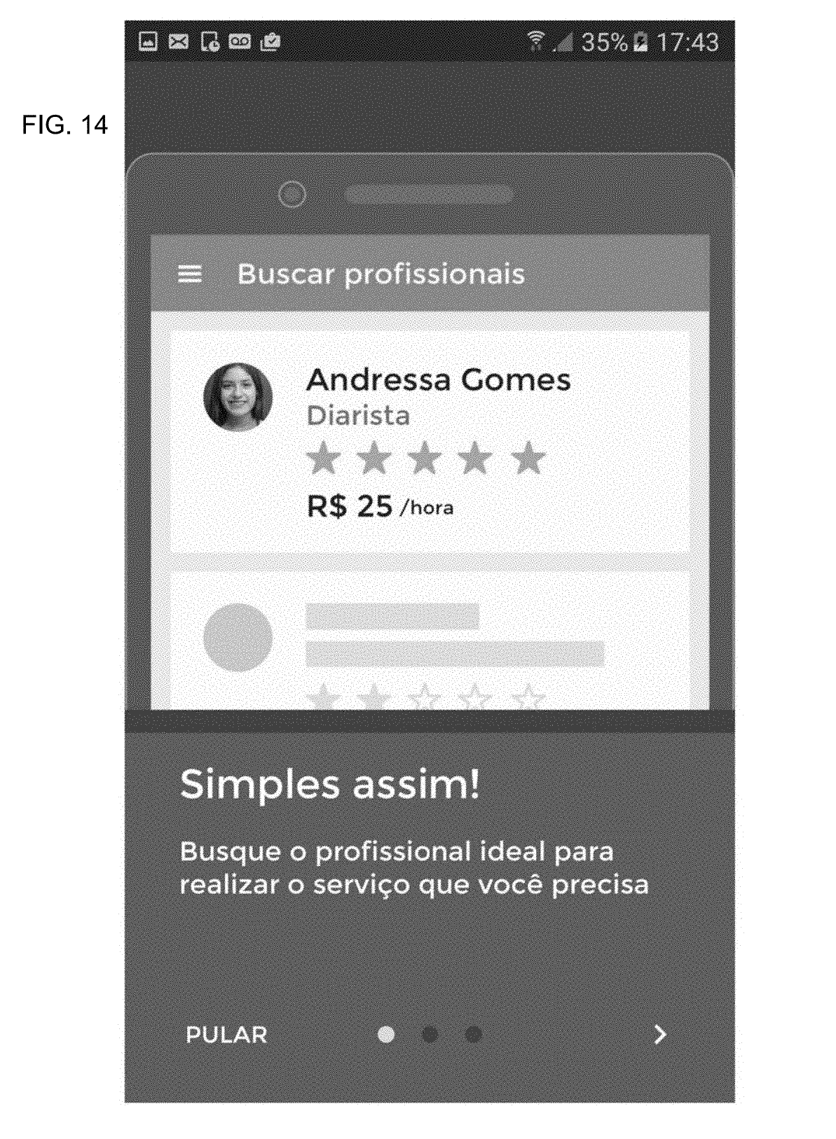

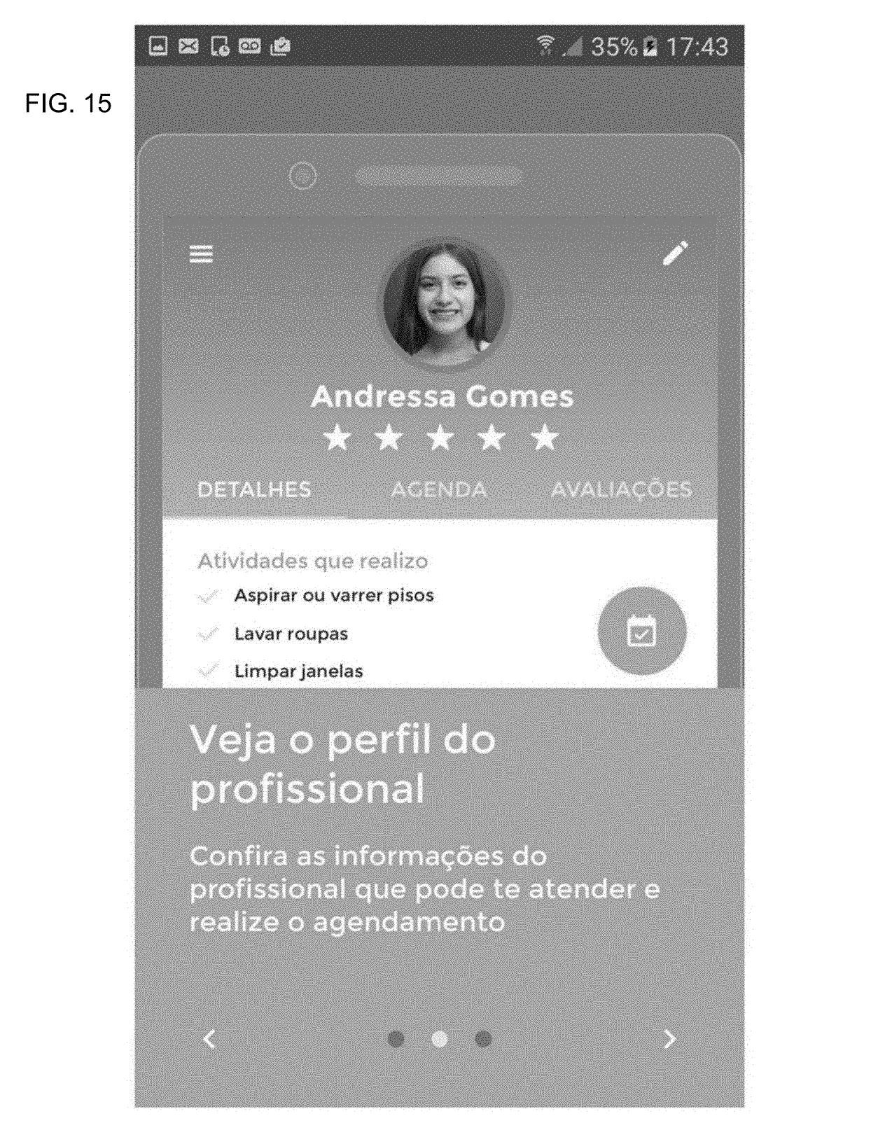

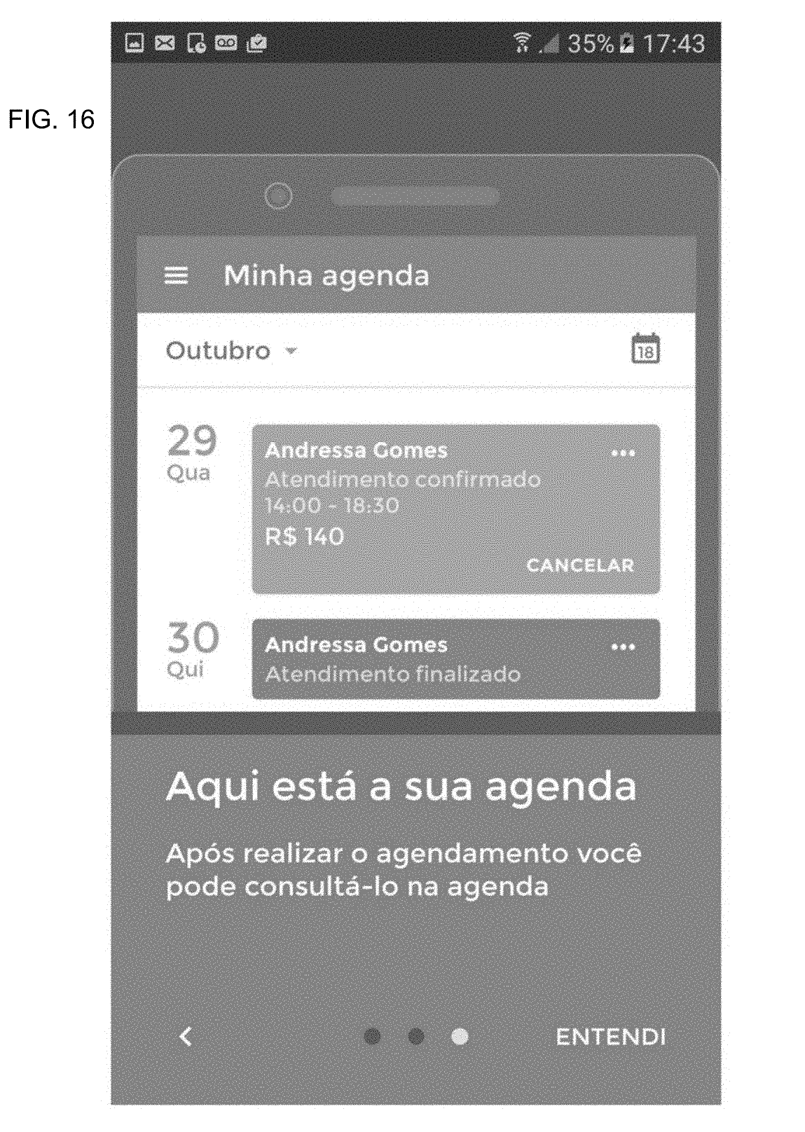

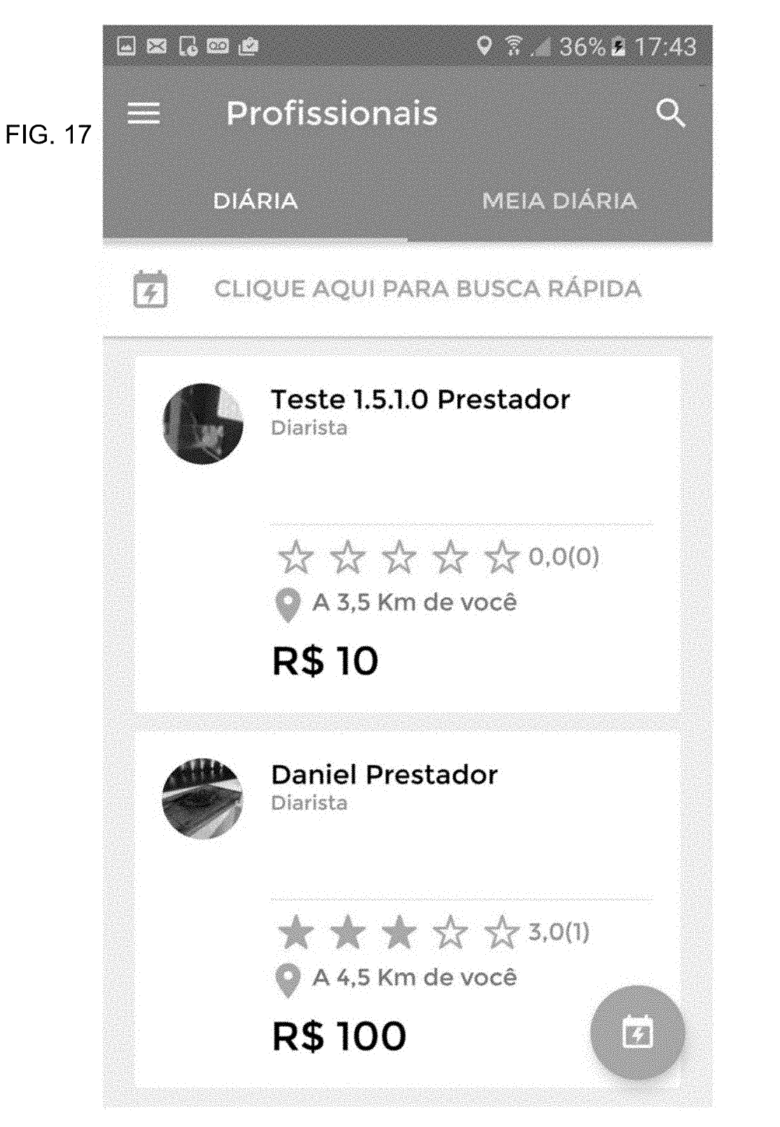

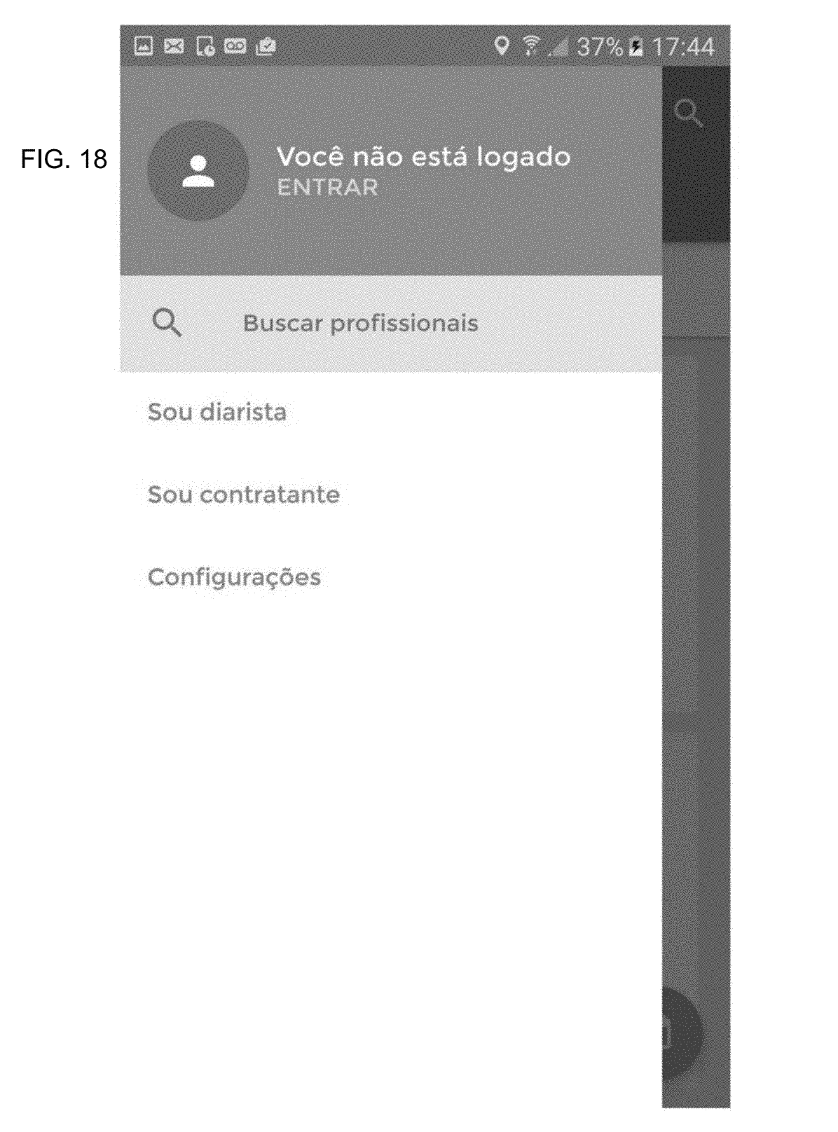

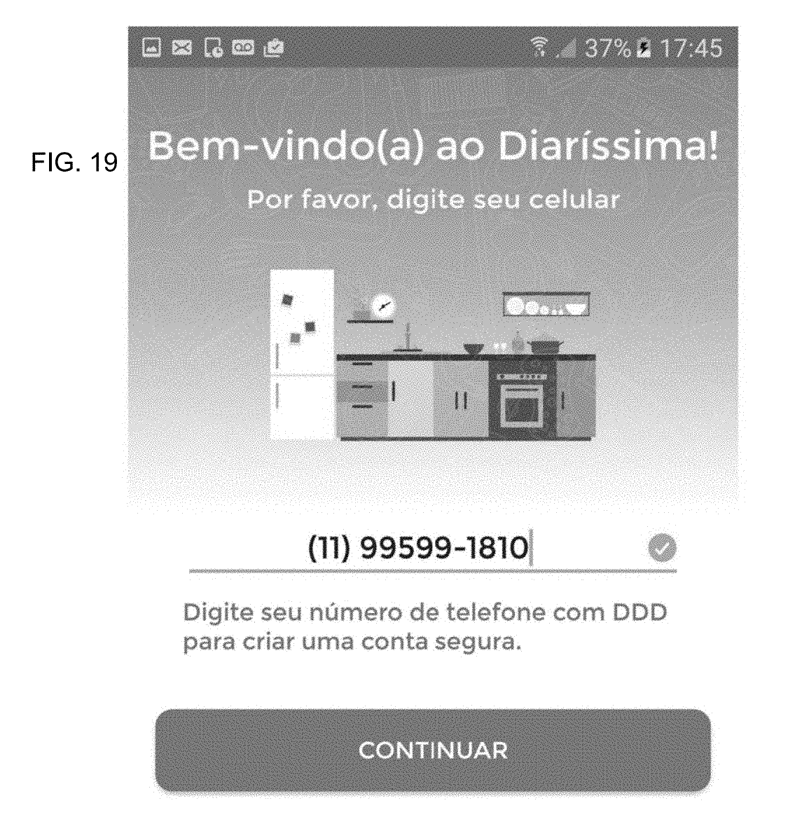

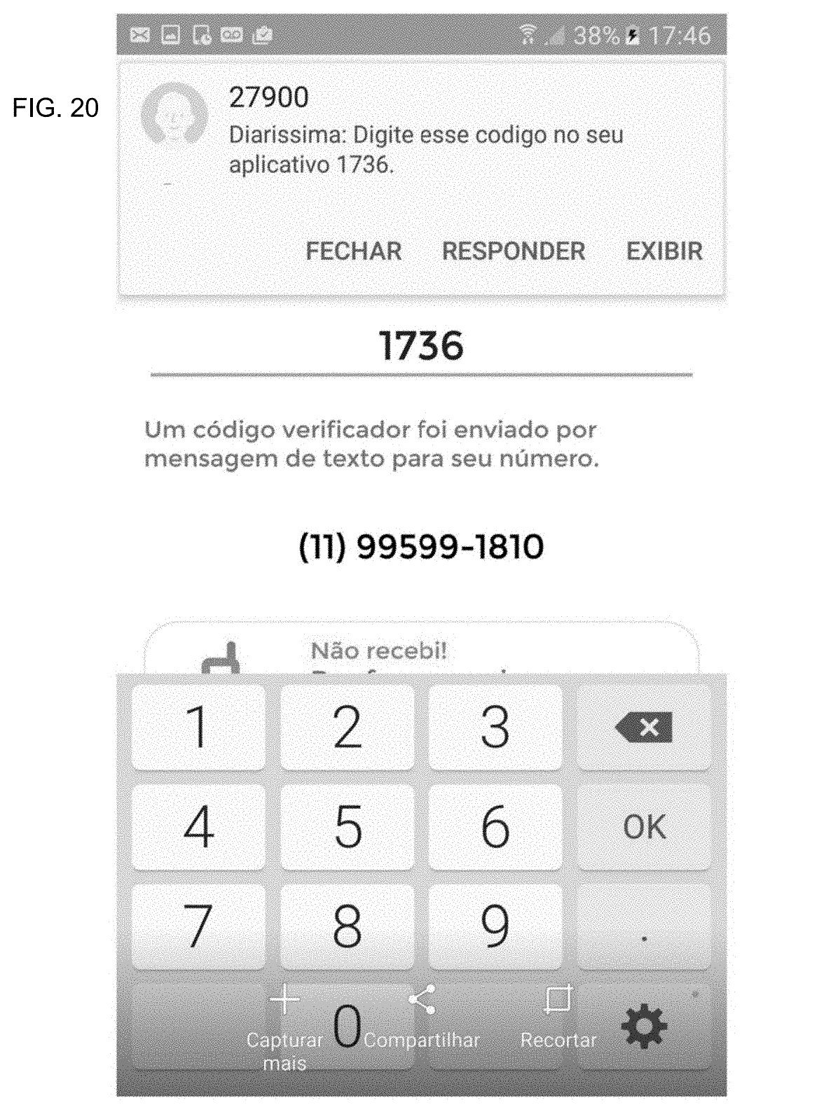

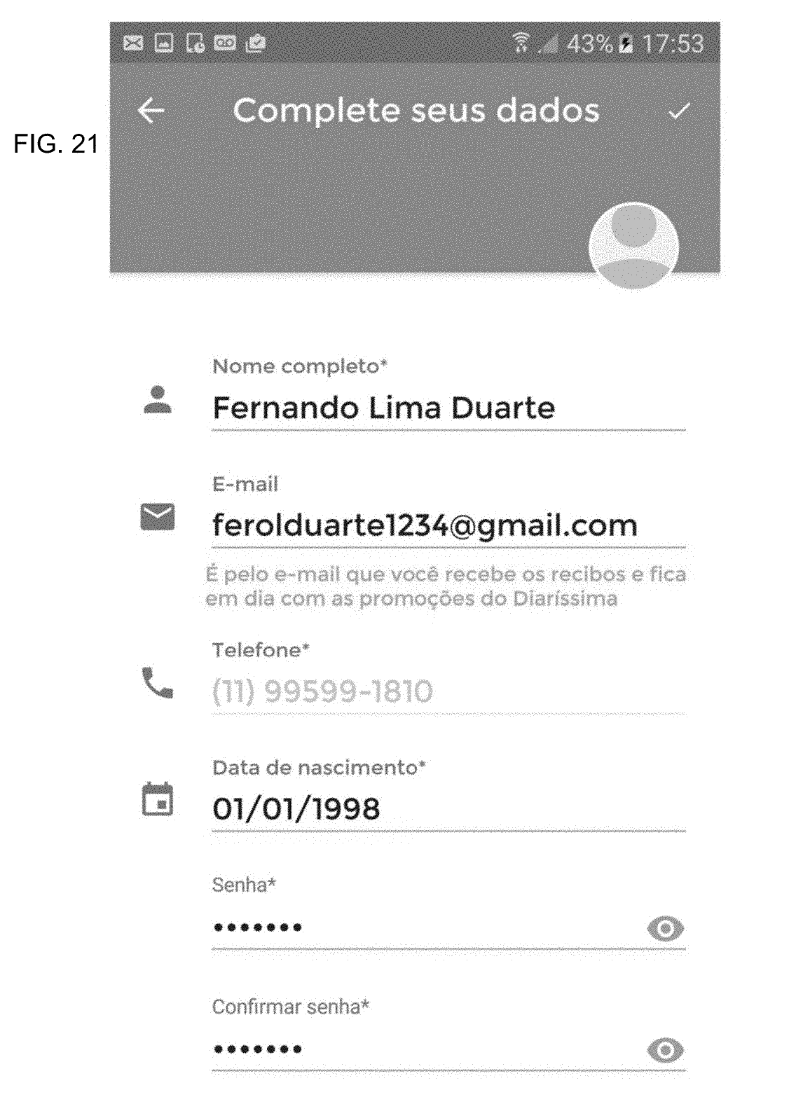

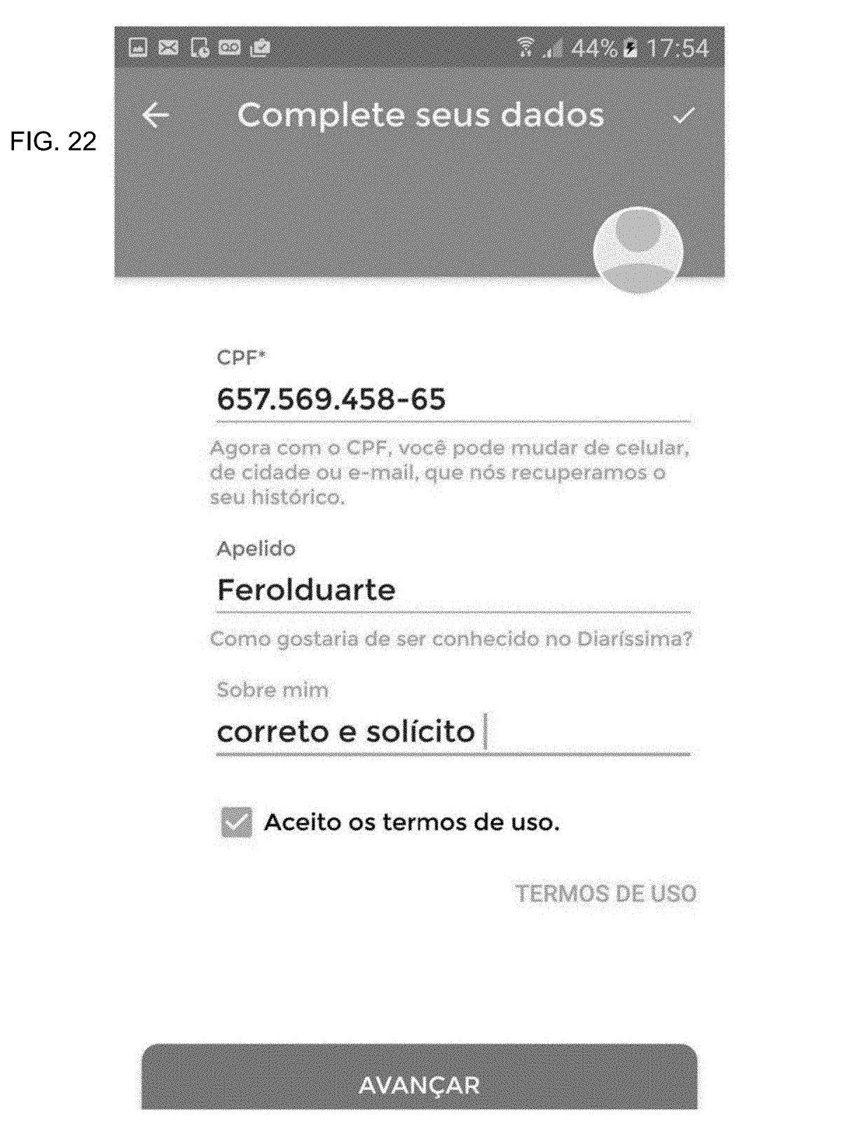

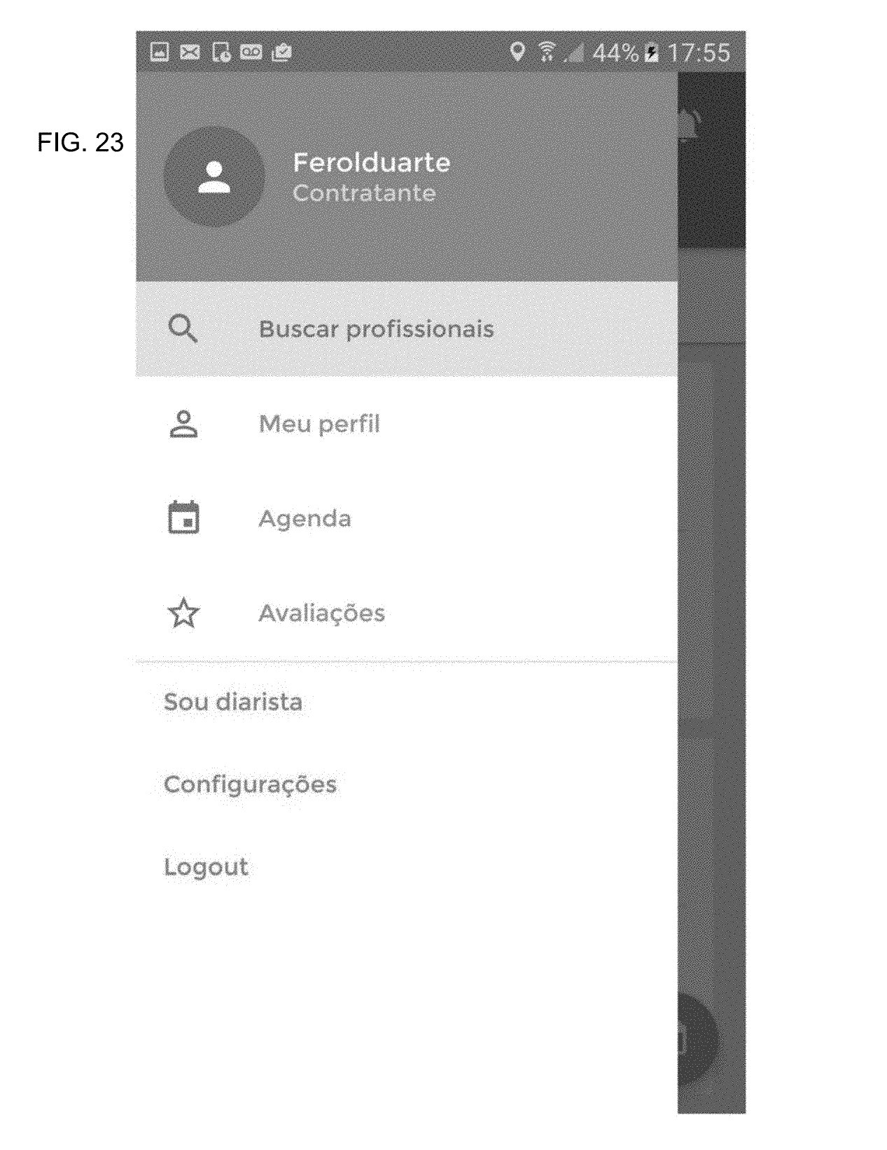

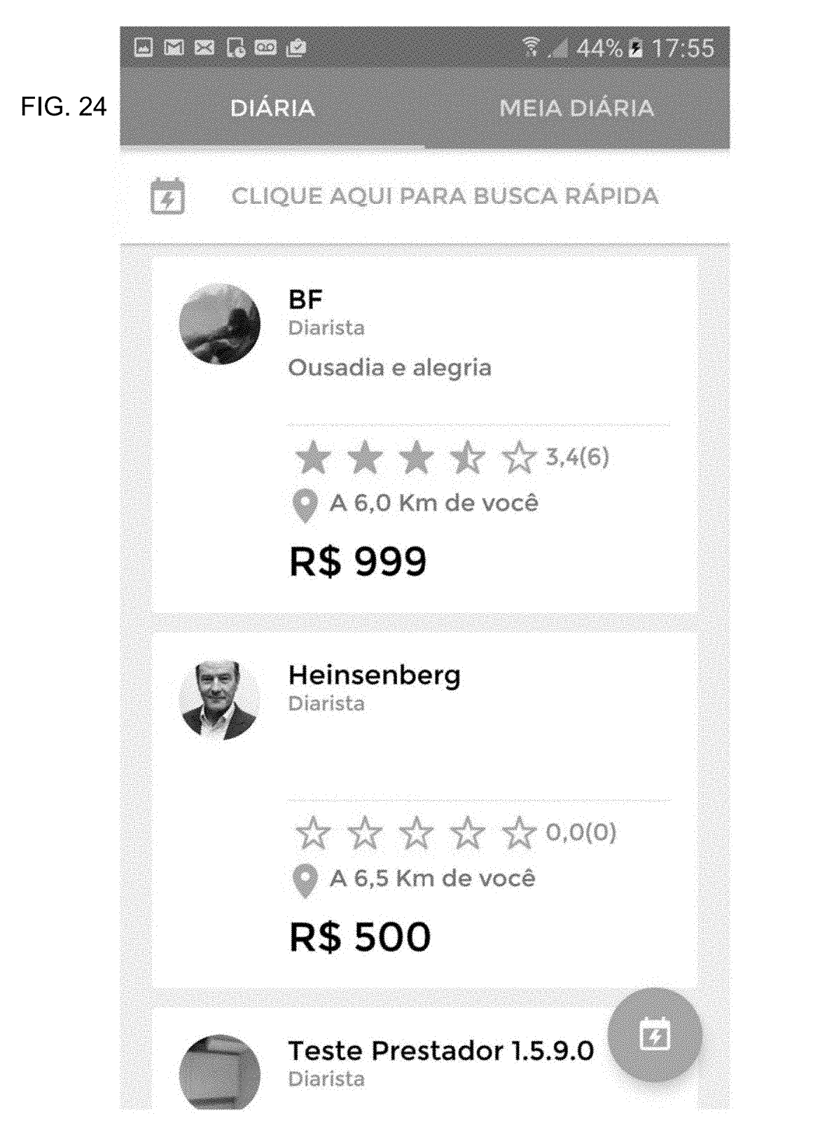

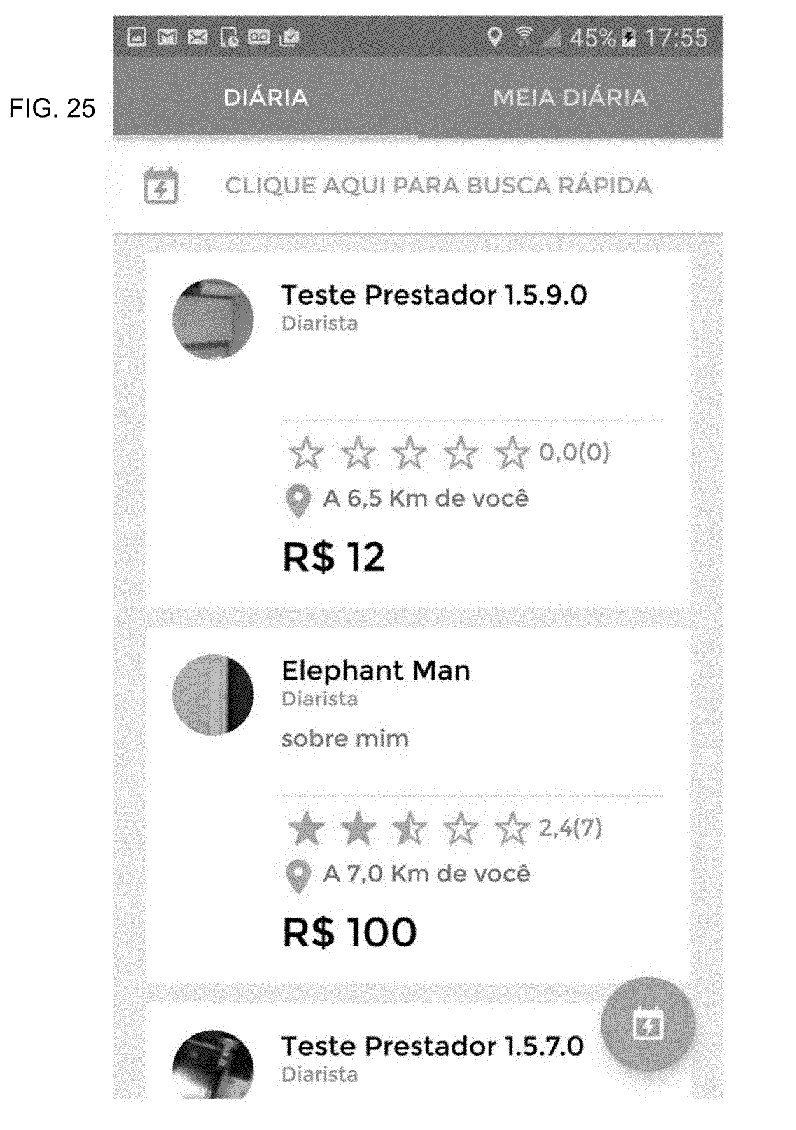

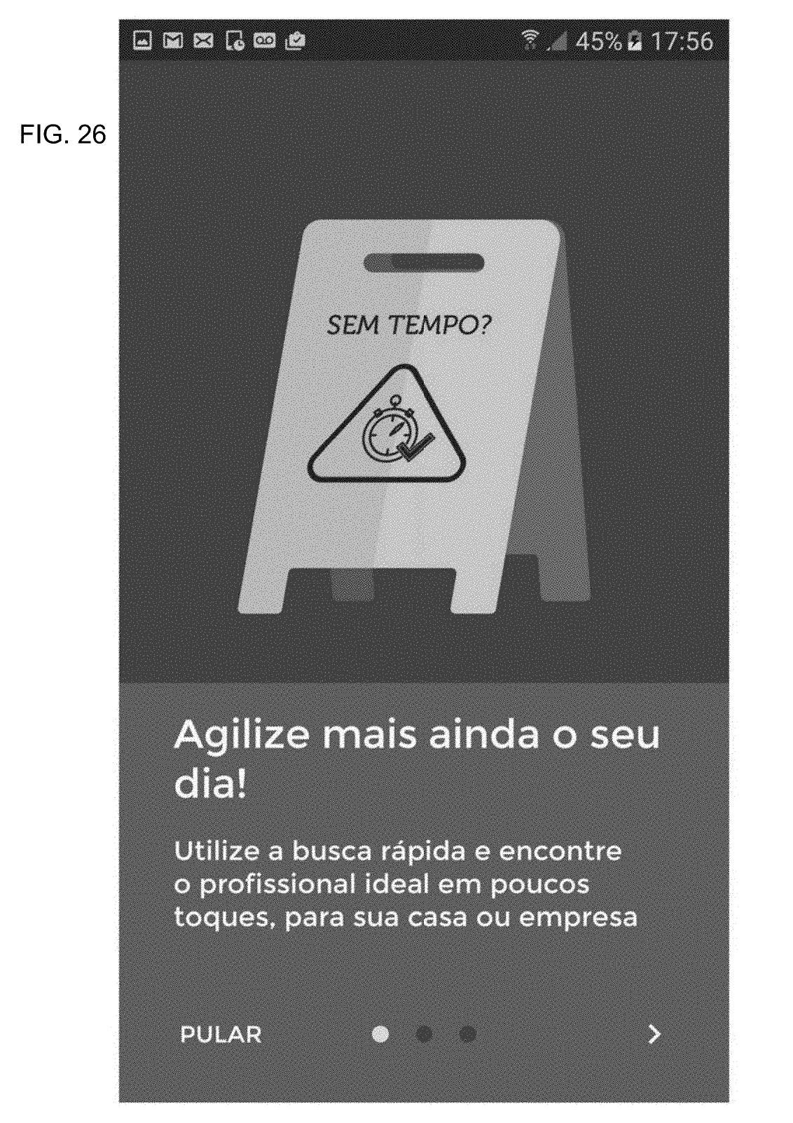

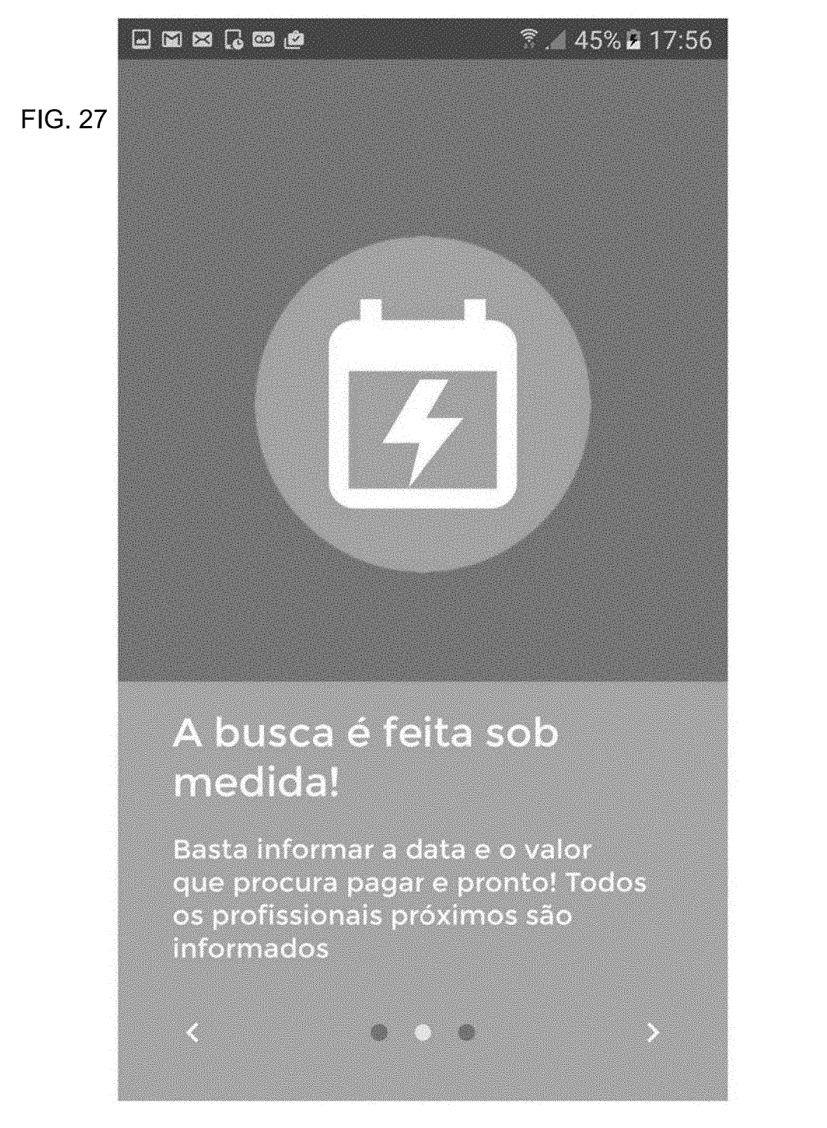

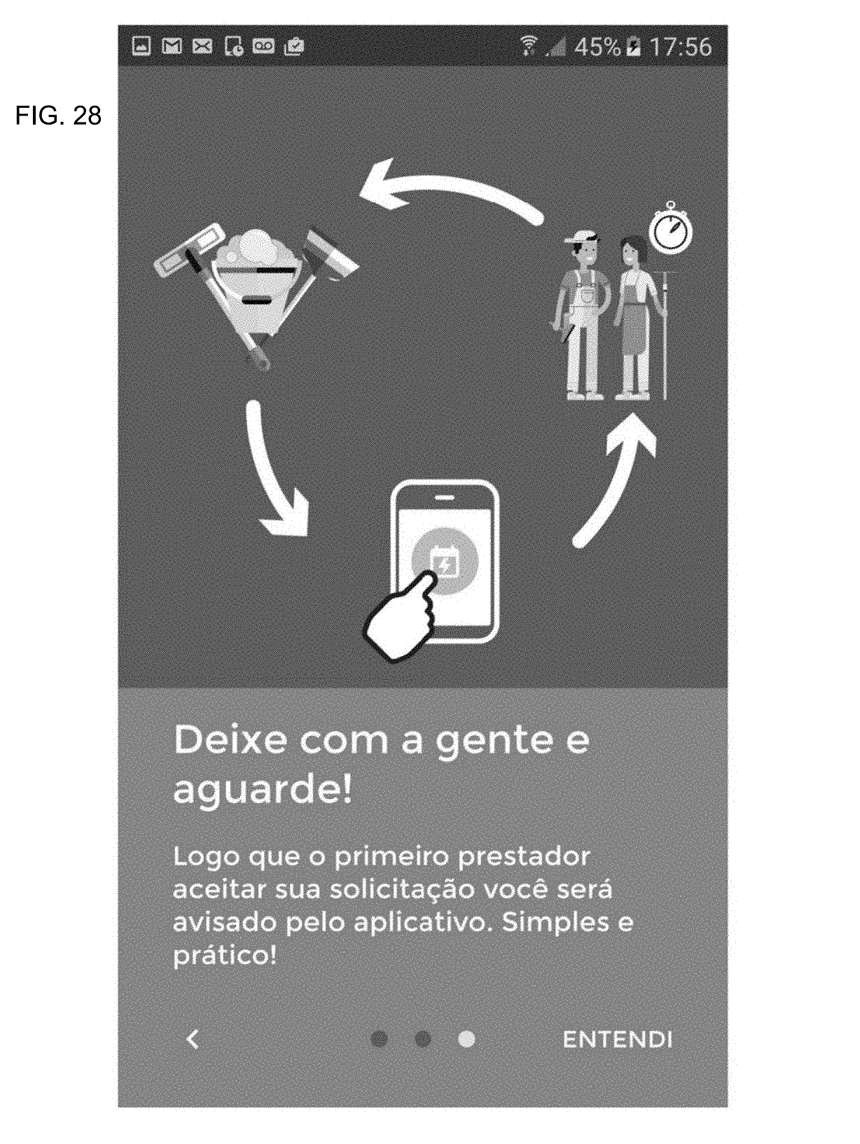

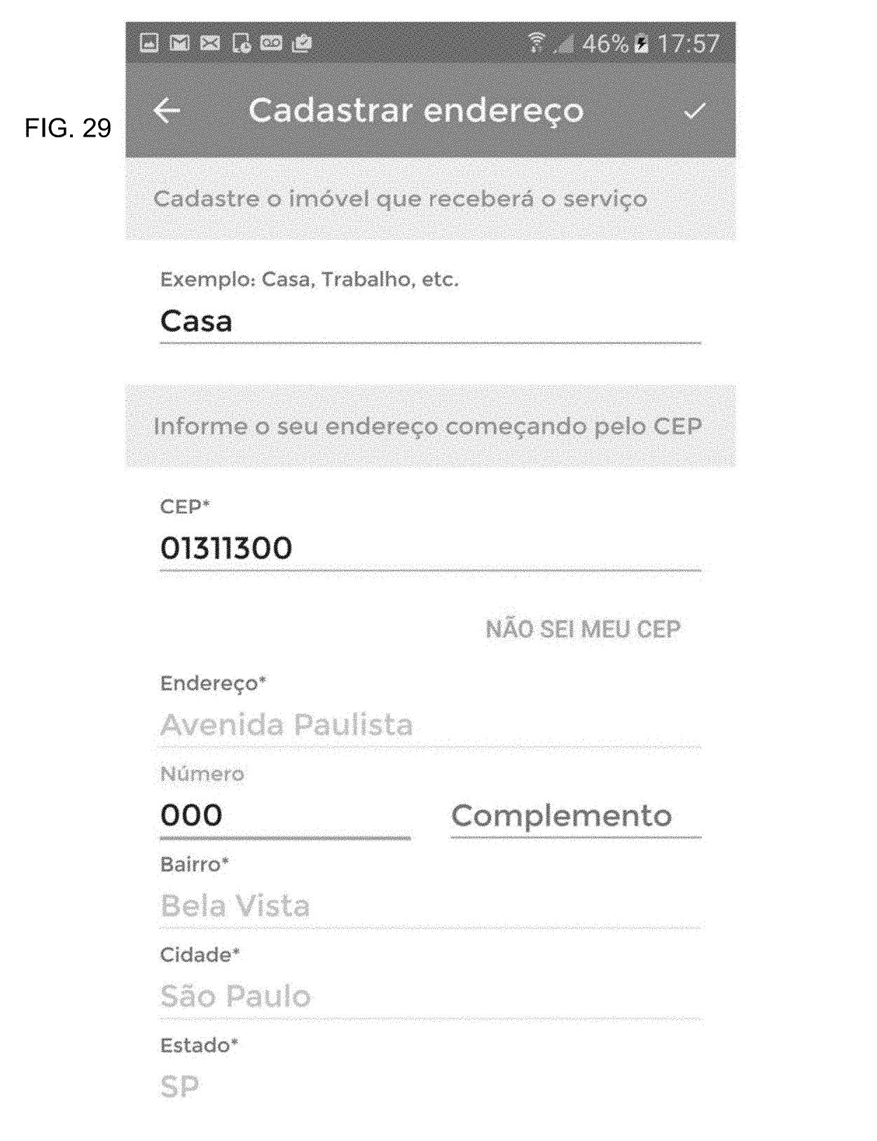

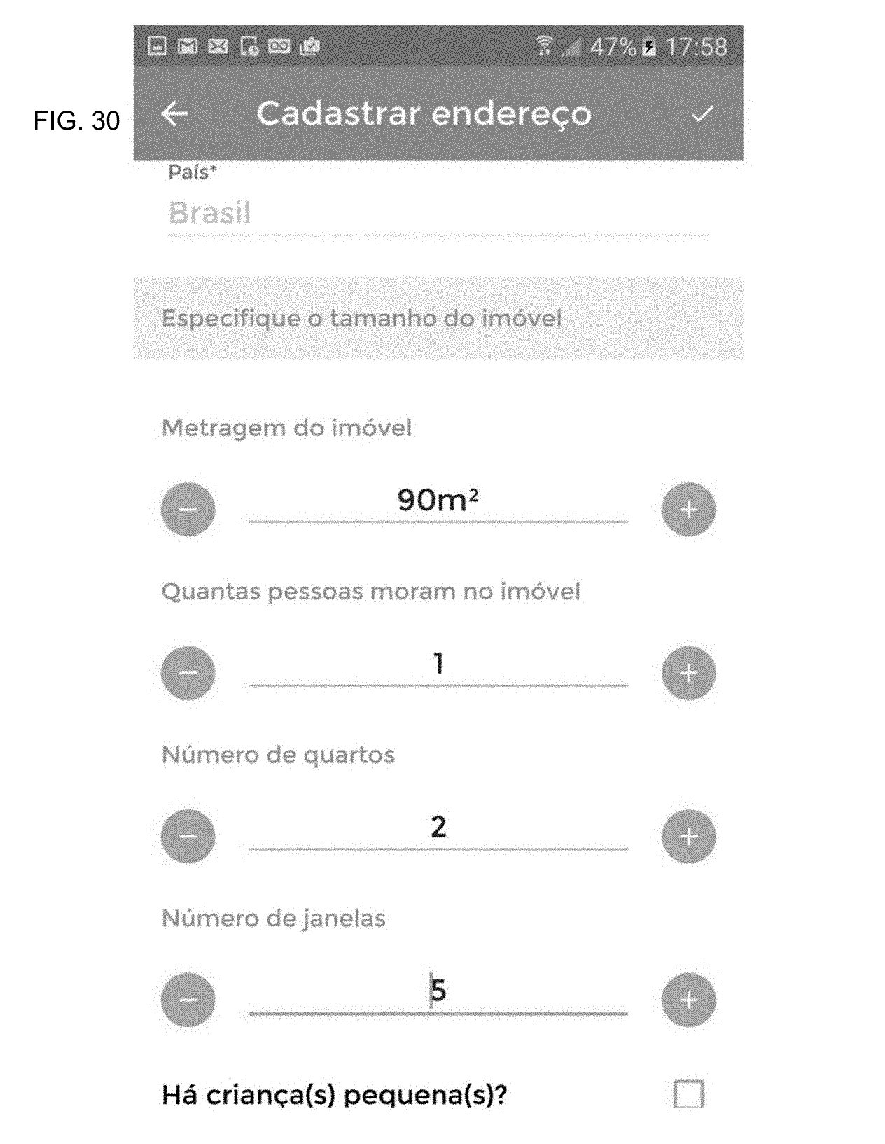

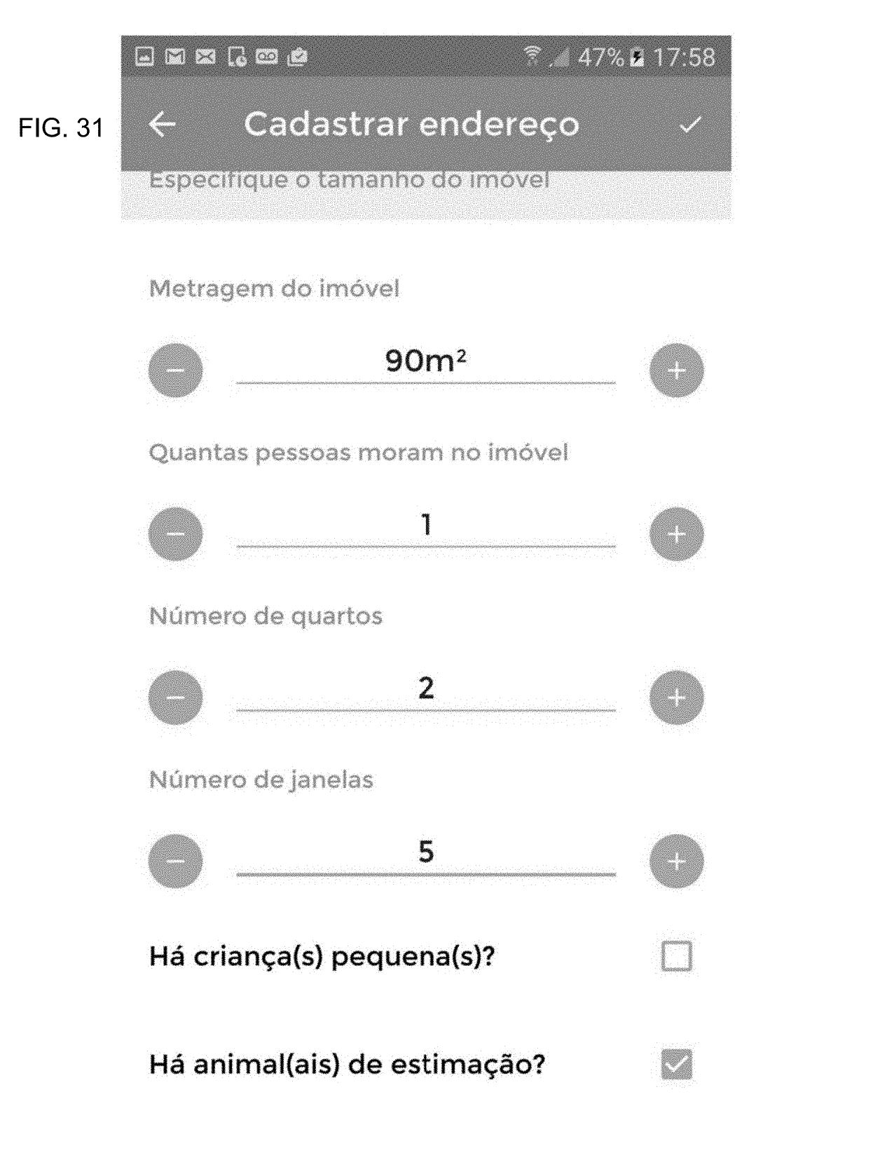

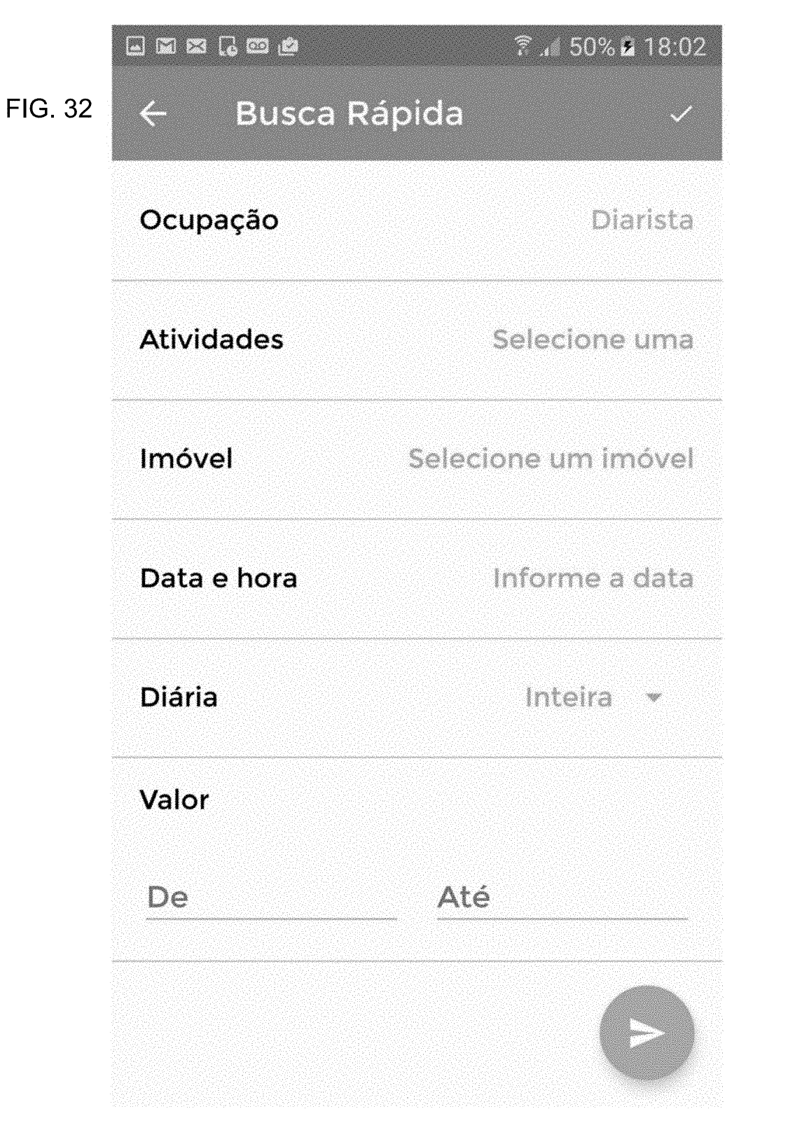

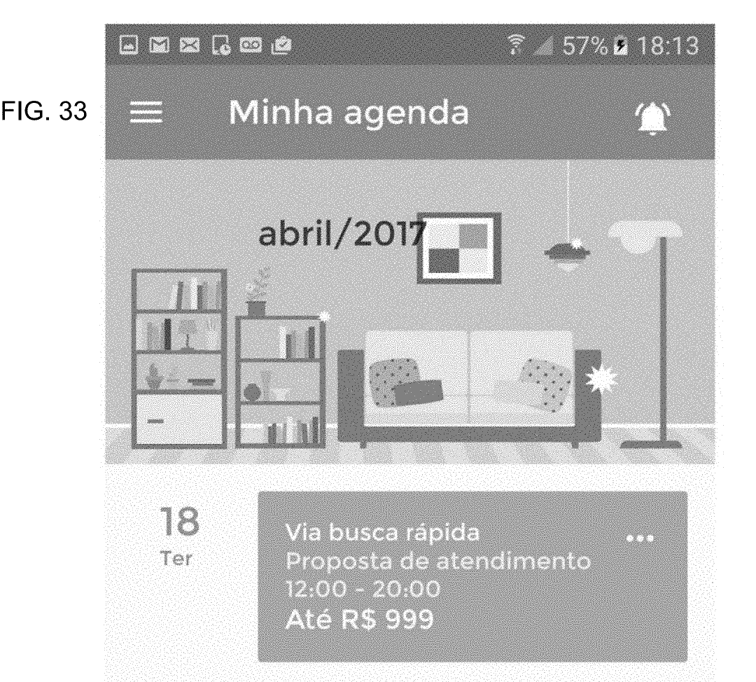

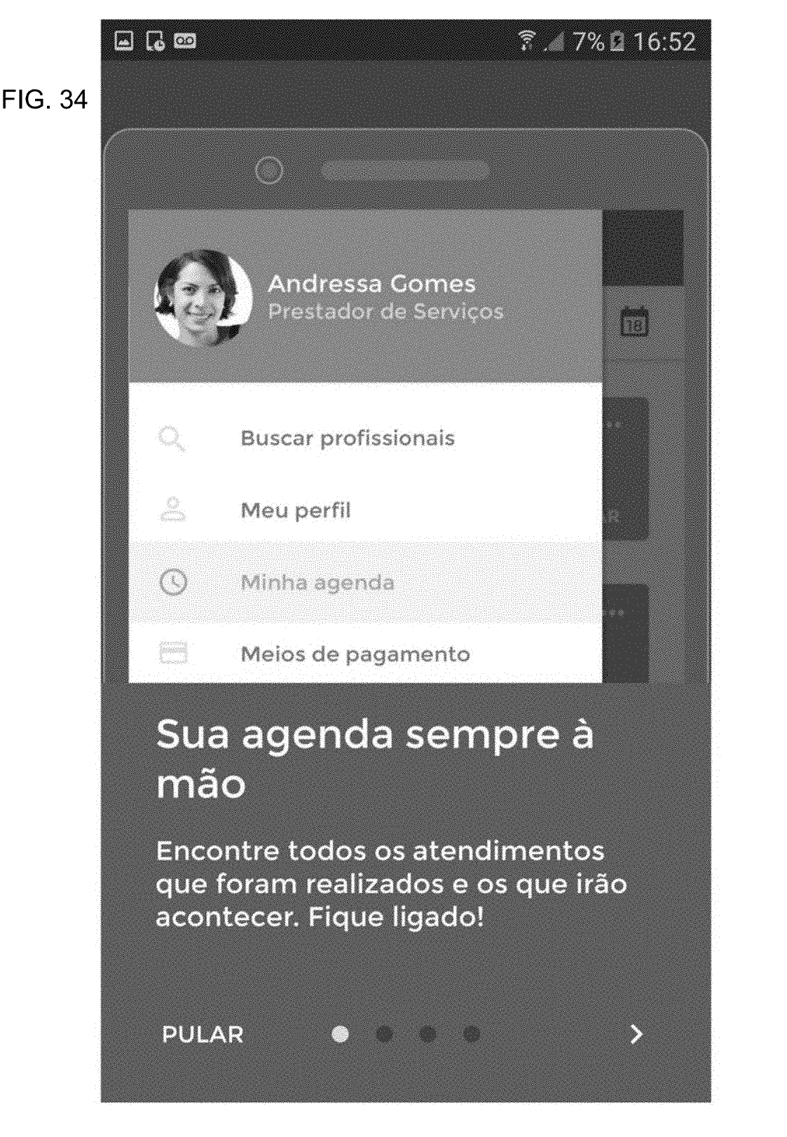

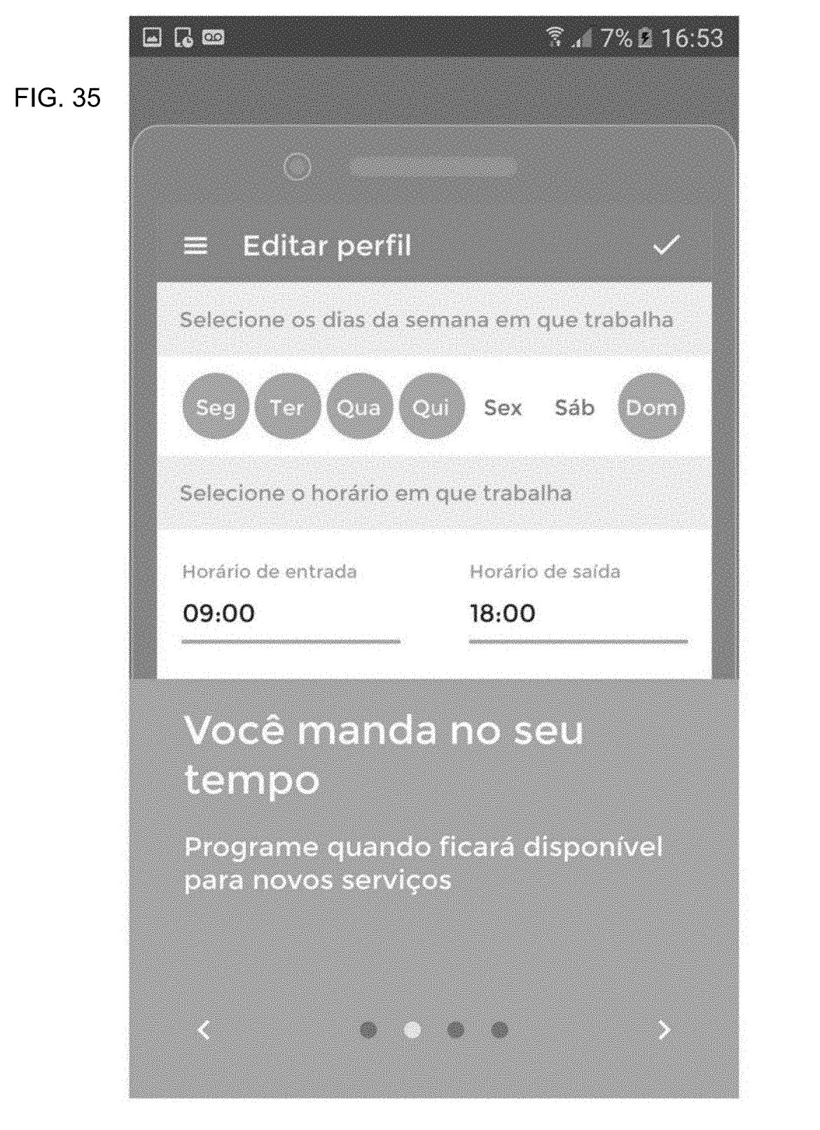

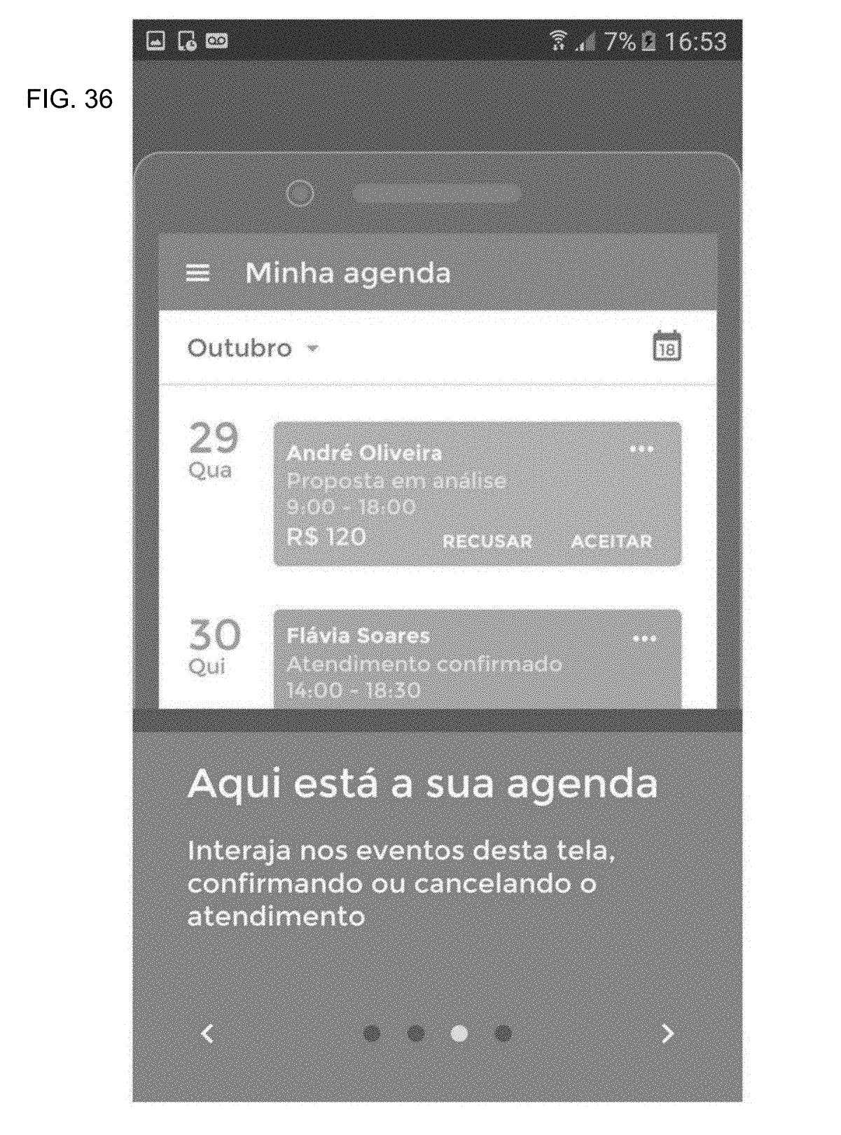

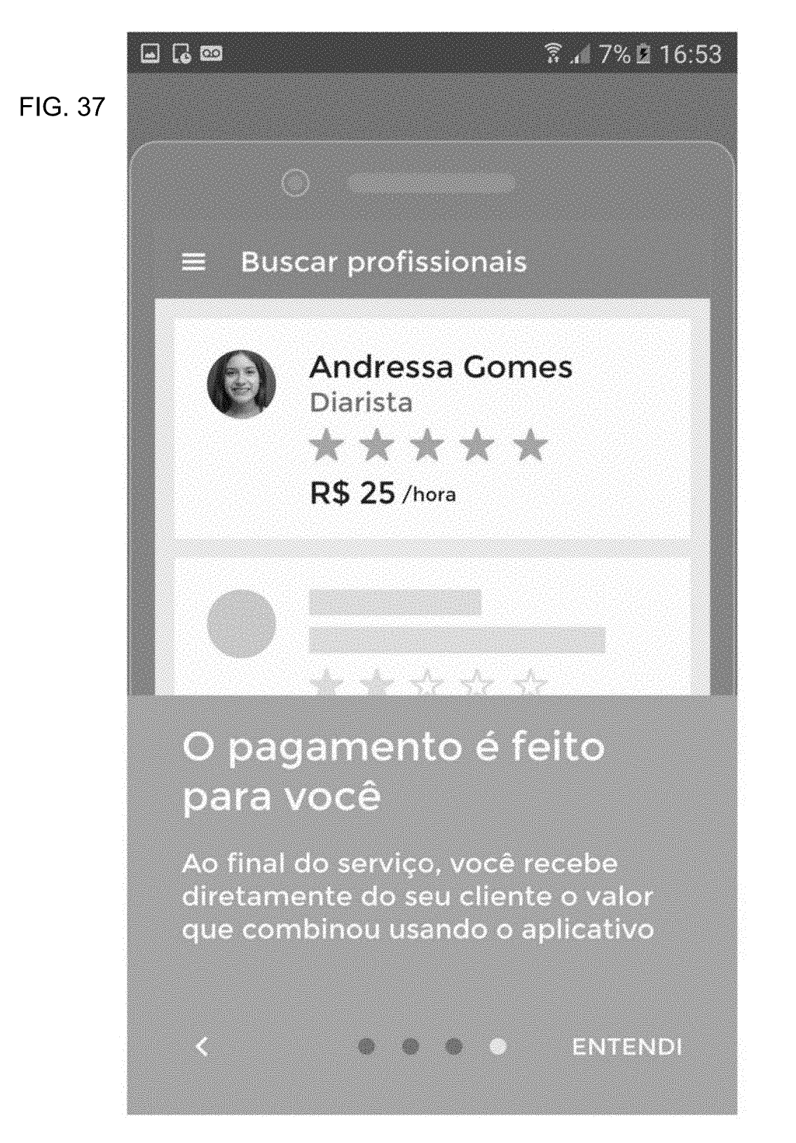

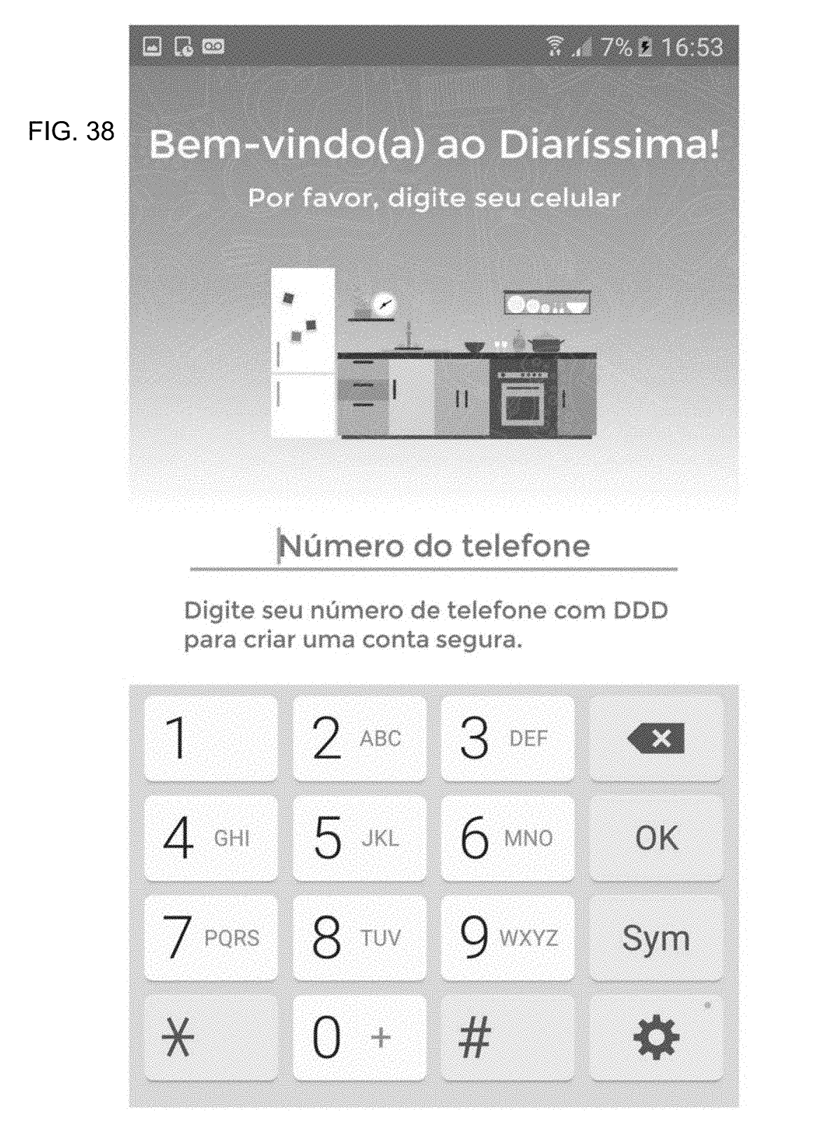

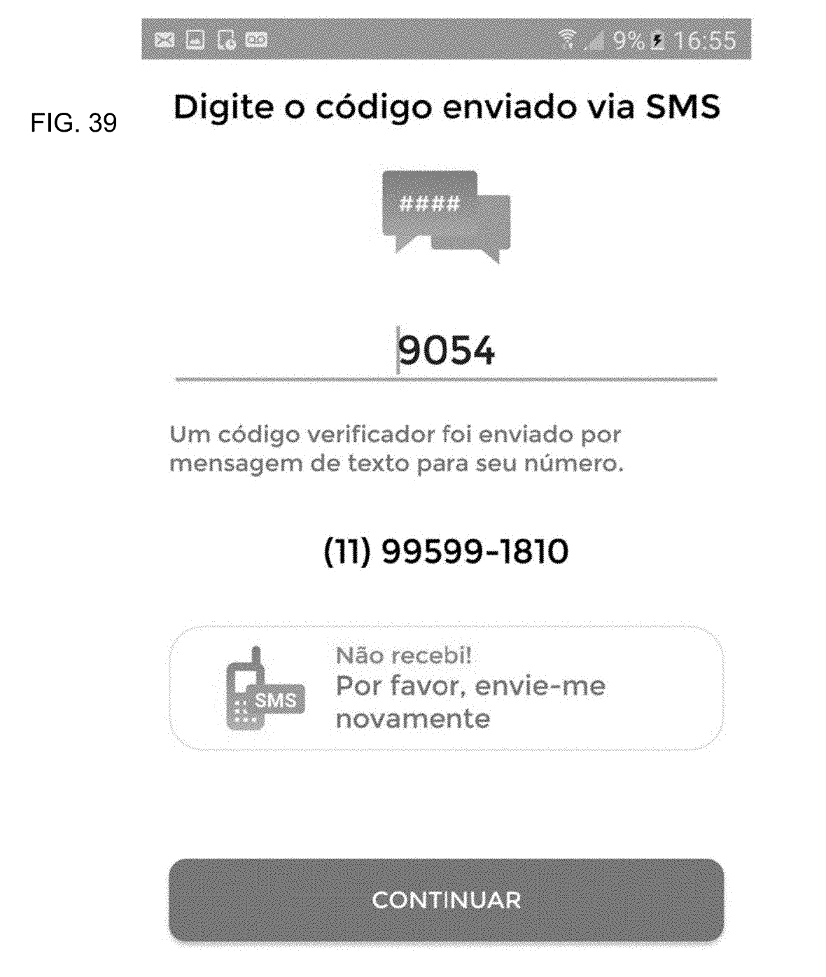

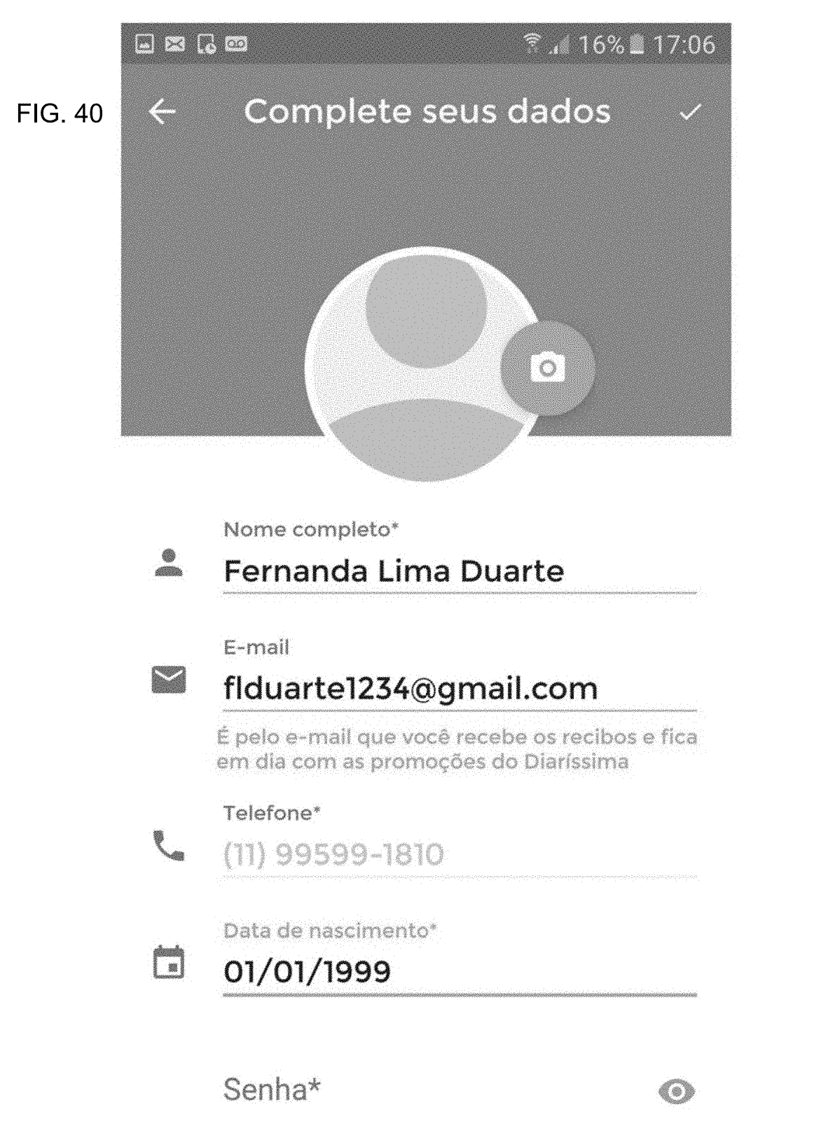

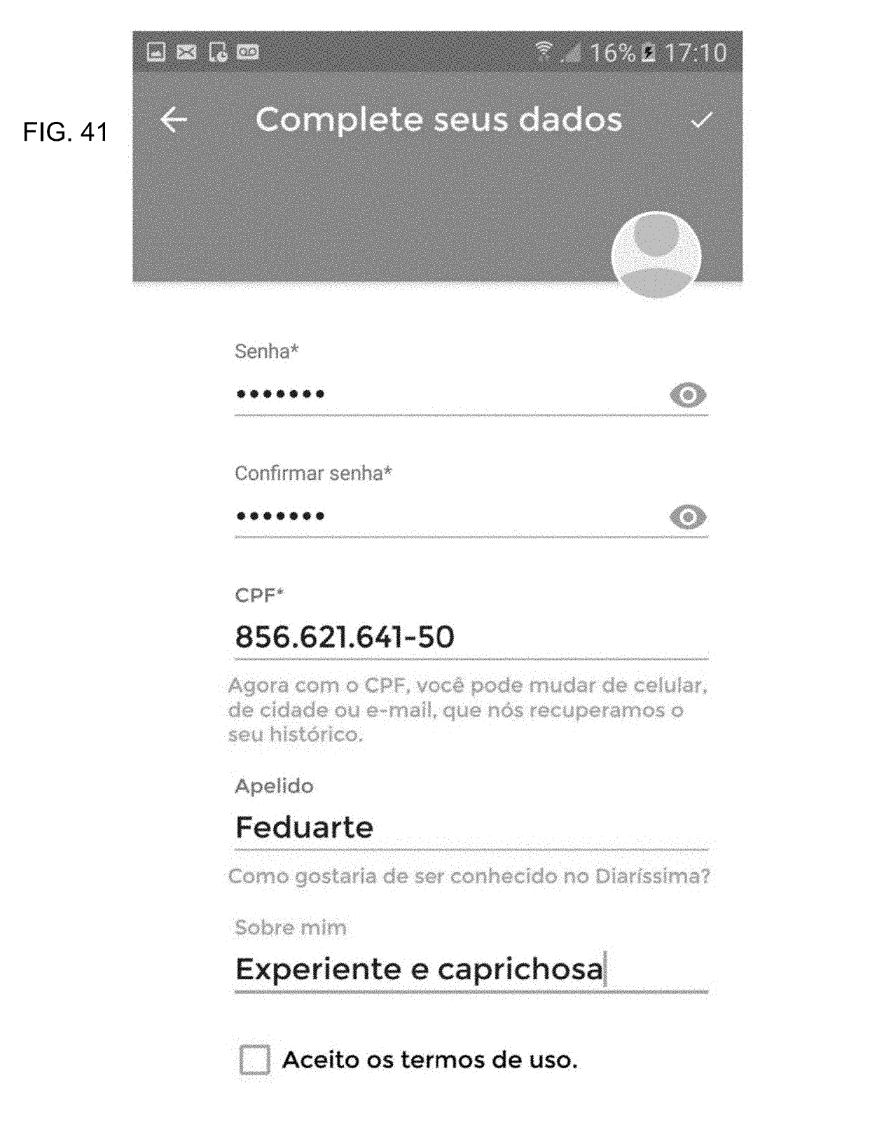

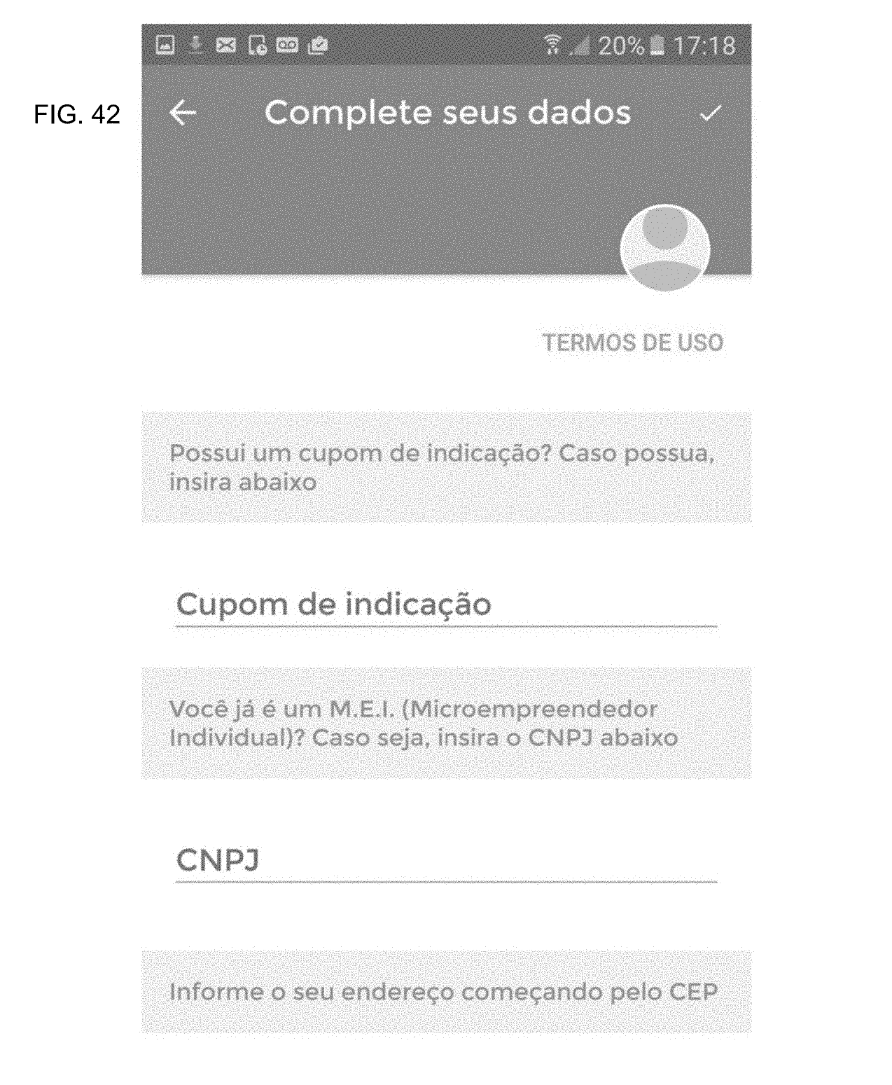

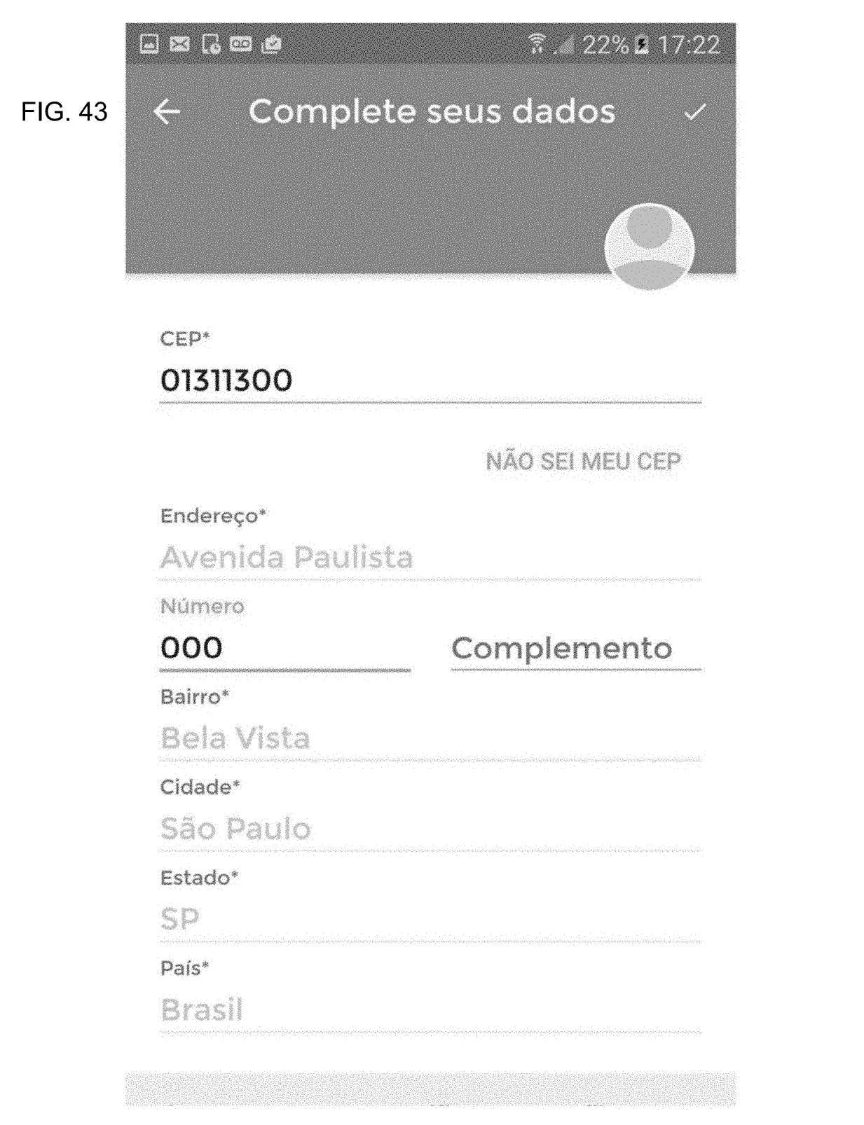

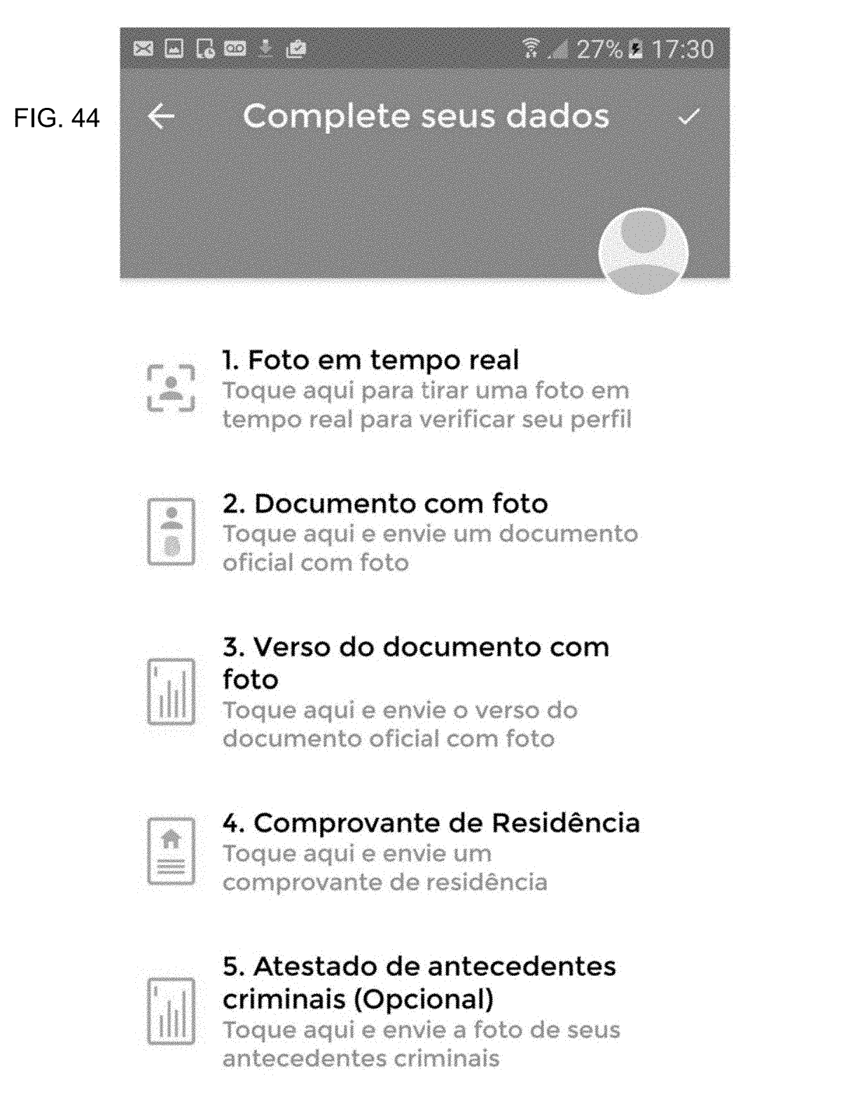

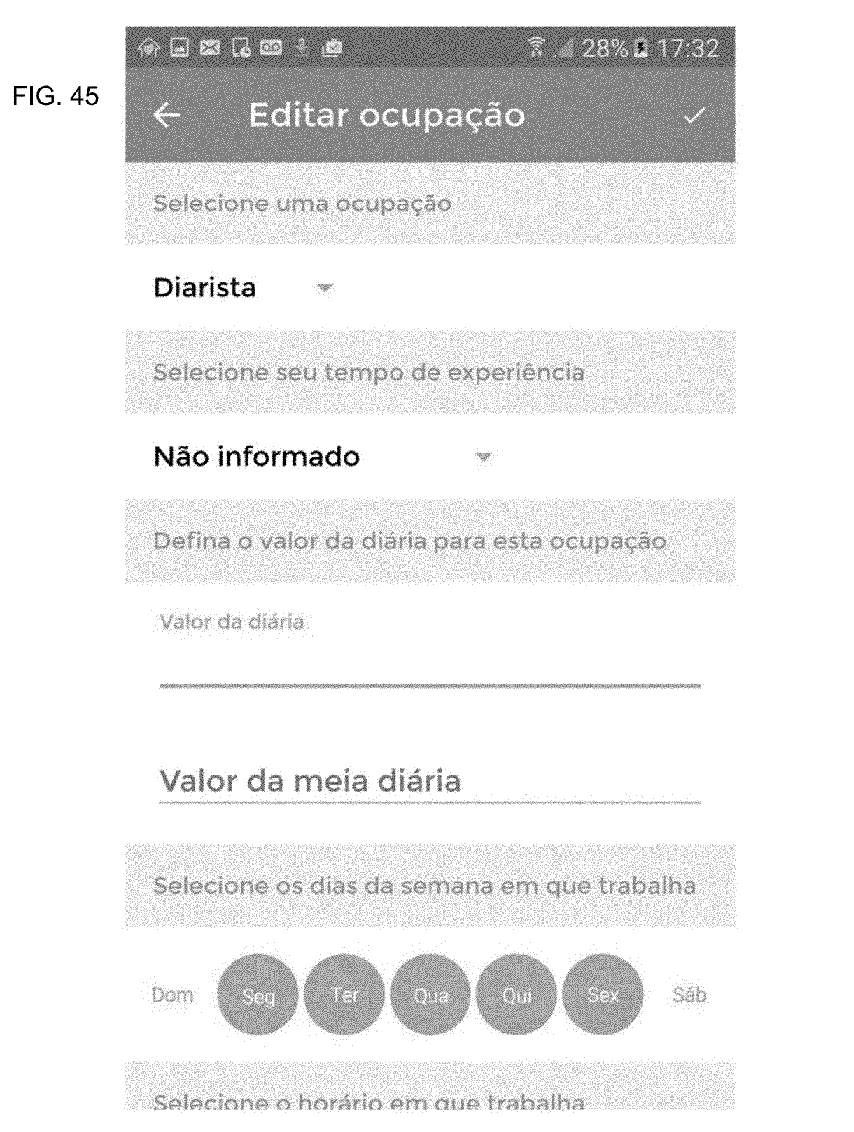

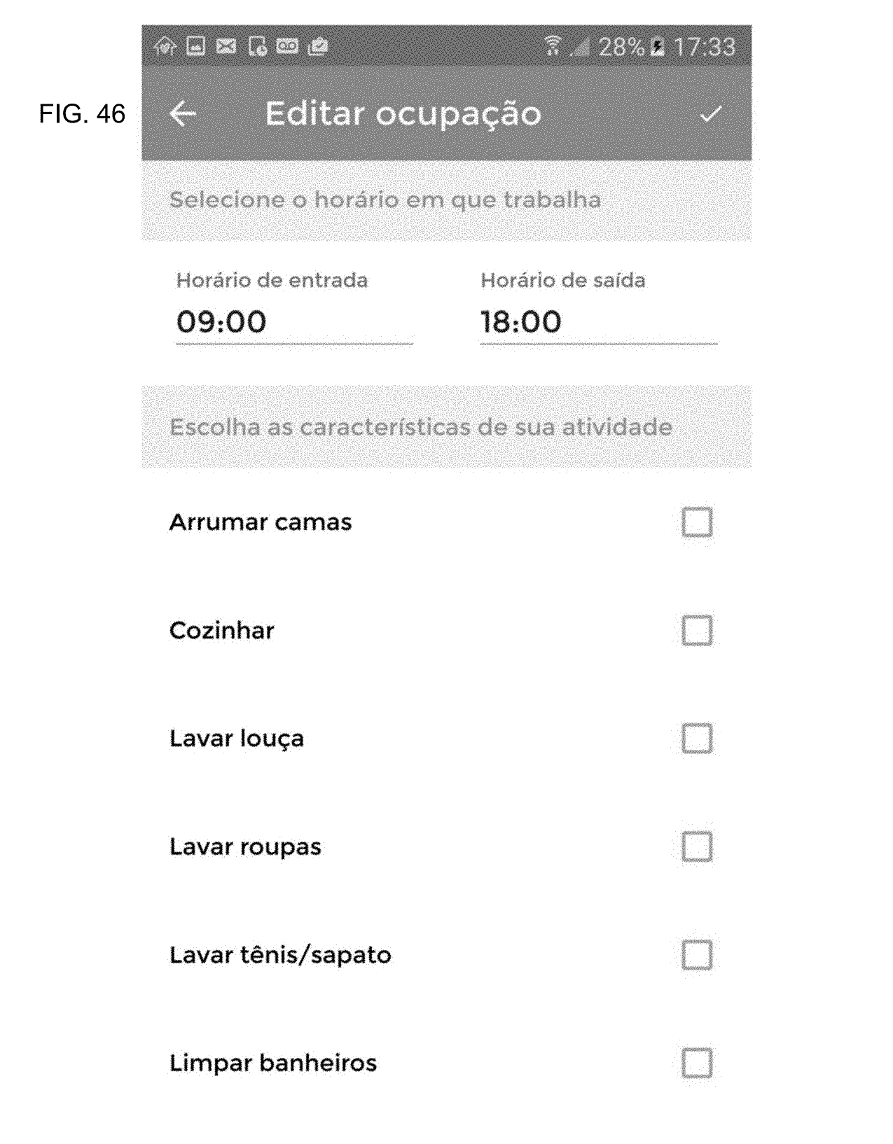

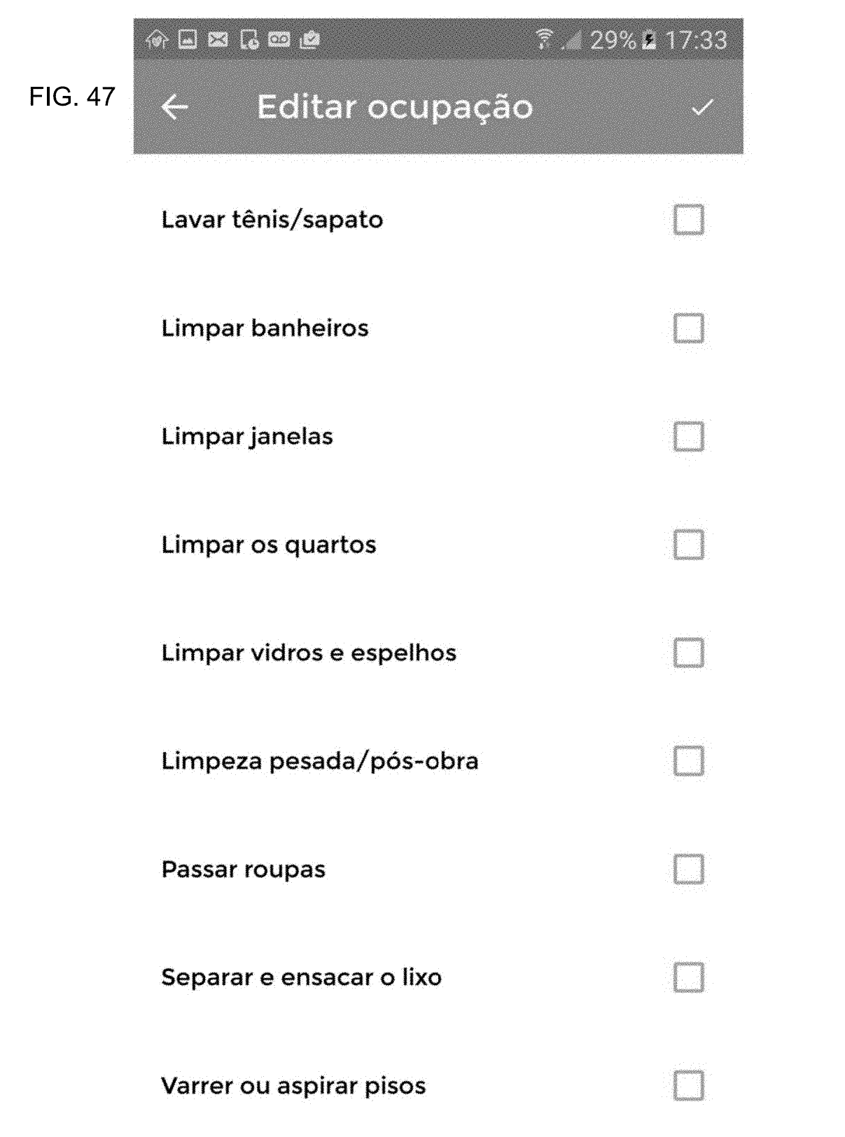

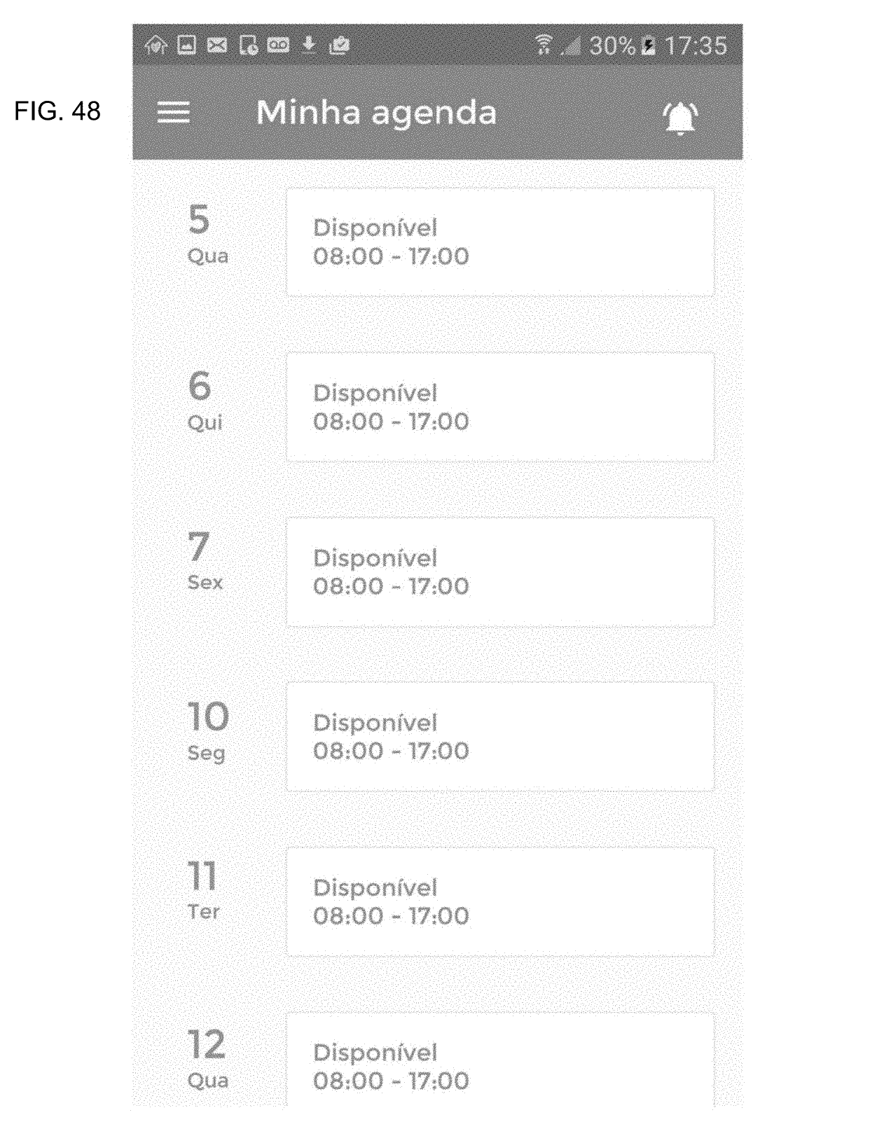

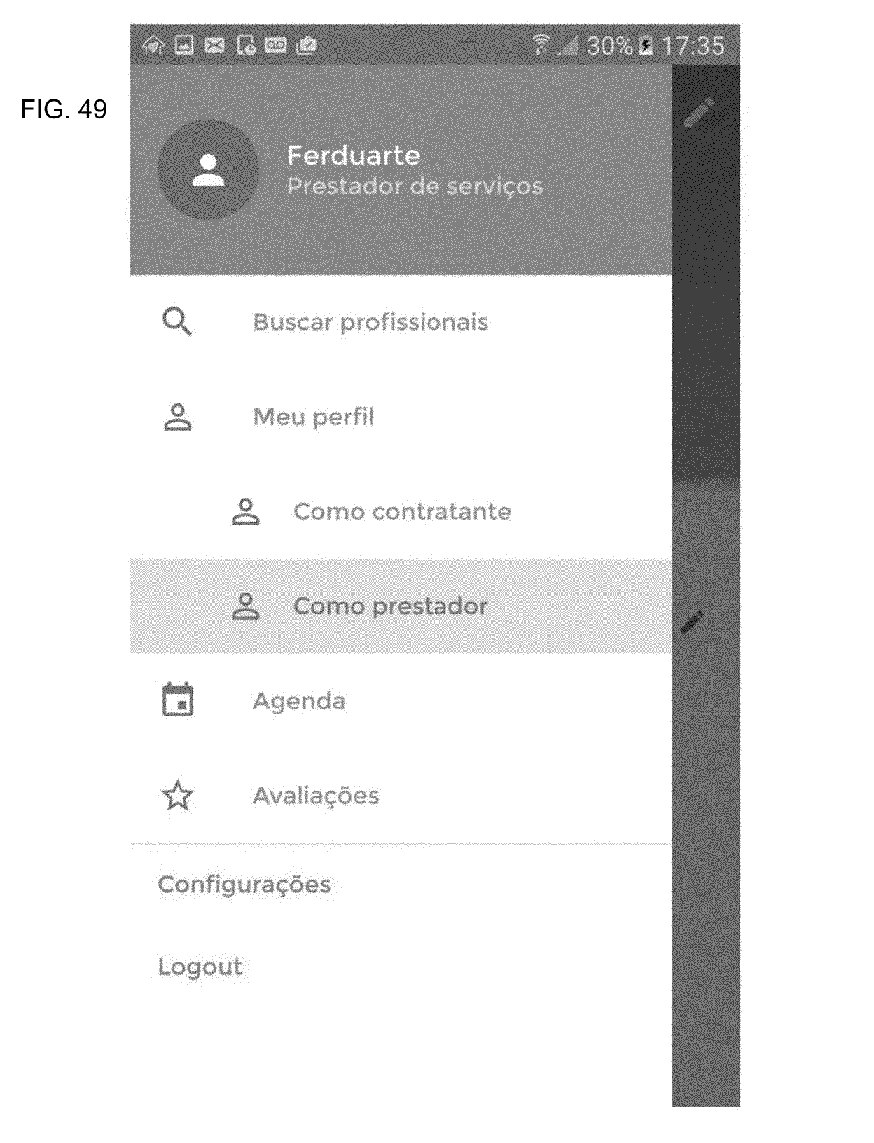

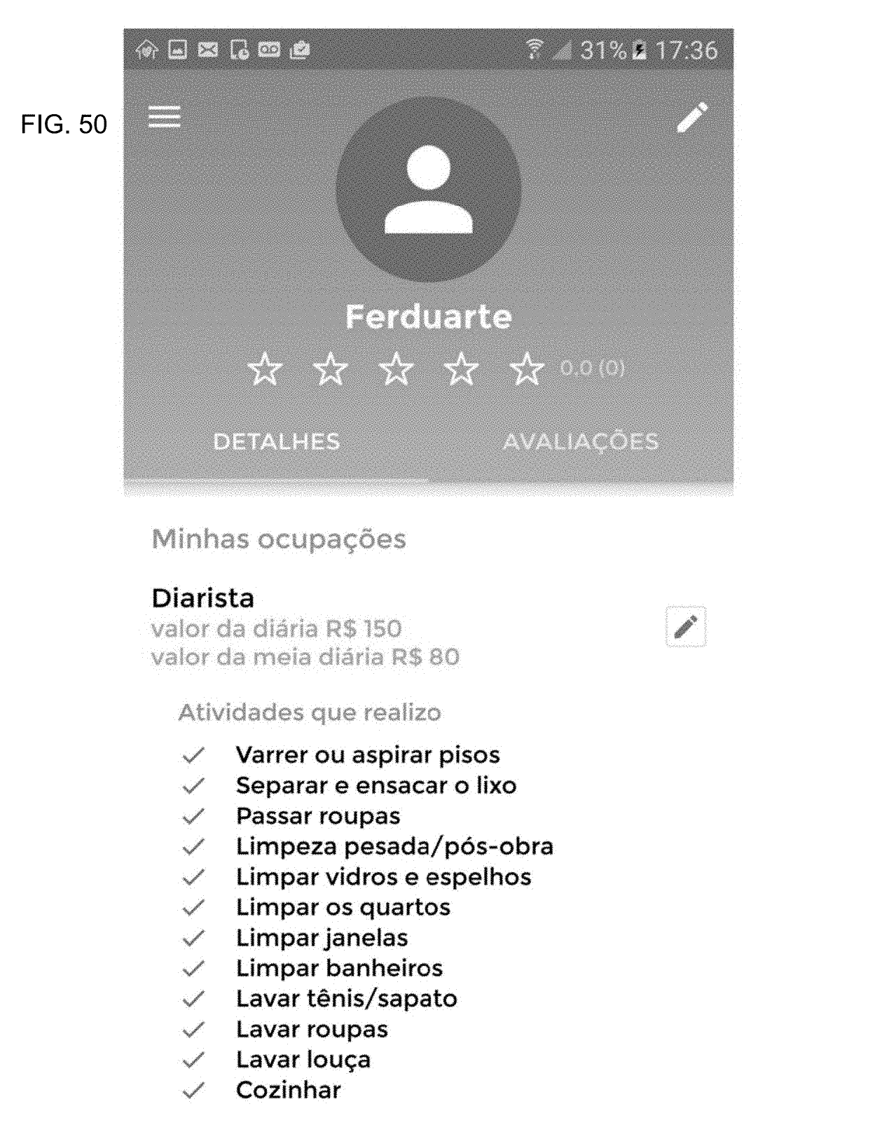

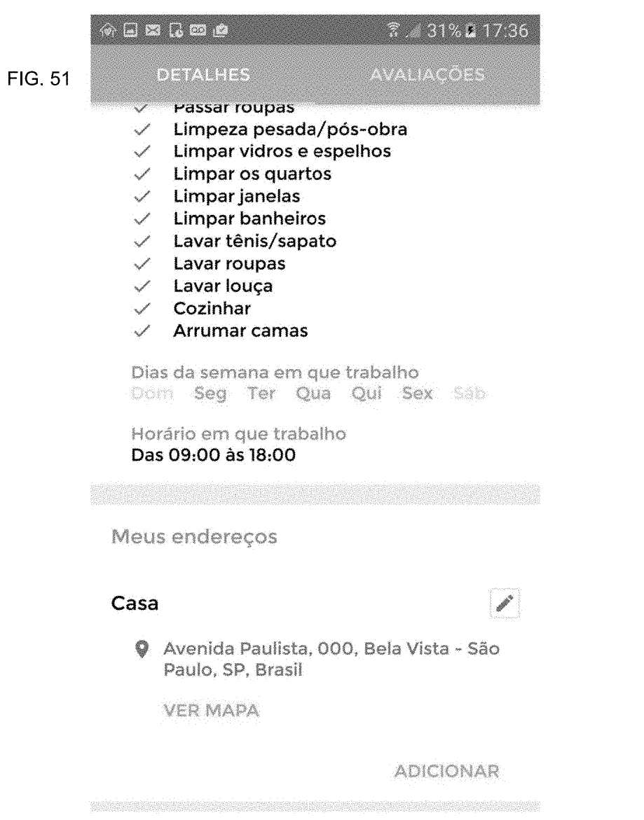

FIGS. 9-51 illustrate example user interactions with the augmented intelligence allocation process according to example implementations as described herein. App integration with other services and other apps, including crowd sourcing, gig economy, retailers, or others: Each integration with our partners is done through the so-called “witted contracts”. Witted for the capability of self-adjustment that each one has. Each witted contract can have the following characteristics: —Title: Internal title for the contract. A partner may have more than one contract.—Descriptions of presentations of the products or services offered by the contract: Descriptions that will be shown to the user at the time of the suggestion of the same. —Detailed product or service Description: Detailed textual description about the product or service. Including, but not limited to cases of use of the particular product or service, and its technical and commercial description, also. —Callback link: Link to the partner's platform to which the user will be redirected at the time of the suggestion of the product or service object of the contract.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method, comprising:
maintaining a knowledge base of profiles for environmental elements and a group of users, wherein each profile comprise at least dependencies, skills, and ratings;
analyzing a request for a service from a user to determine a set of resource parameters;
determining relationships for each profile in the knowledge base in view of the request;
generating a ranking model for the profiles based at least on the dependencies of the determined relationships in view of the resource parameters;
prompting the user for feedback on a set of profiles that satisfy the resource parameters based on the ranking;
adjusting the ranking model based on similarity calculations of the profiles in view of ratings from the profile of the user;
updating the knowledge based on the user feedback; and
providing one or more options based on the adjusted ranking model that satisfy the resource parameters.

2. The method of claim 1, wherein maintaining the knowledge base comprise organizing input data according to at least one of the dependencies, skills, and rating.

3. The method of claim 1, wherein determining relationships comprises categorizing relationships as at least one of a primary relationship, an adjacent relationship, a direct adjacent relationship.

4. The method of claim 1, wherein generating the ranking model further comprises synthesizing the profiles to determine a feasibility factor for the service.

5. The method of claim 1, wherein prompting the user for feedback is via an audio interface.

6. The method of claim 1, further comprising prompting another user for feedback on the request or to limits for one or more of the resource parameters.

7. A system comprising:
a knowledge base of profiles for environmental elements and a group of users, wherein each profile comprise at least dependencies, skills, and ratings;
a processor, operatively coupled to the repository, the processor to:
maintain the knowledge base;
analyze a request for a service from a user to determine a set of resource parameters;
determine relationships for each profile in the knowledge base in view of the request;
generate a ranking model for the profiles based at least on the dependencies of the determined relationships in view of the resource parameters;
prompt the user for feedback on a set of profiles that satisfy the resource parameters based on the ranking;
adjust the ranking model based on similarity calculations of the profiles in view of ratings from the profile of the user;
update the knowledge based on the user feedback; and
provide one or more options based on the adjusted ranking model that satisfy the resource parameters.

8. The system of claim 7, wherein maintaining the knowledge base comprise organizing input data according to at least one of the dependencies, skills, and rating.

9. The system of claim 7, wherein determining relationships comprises categorizing relationships as at least one of a primary relationship, an adjacent relationship, a direct adjacent relationship.

10. The system of claim 7, wherein generating the ranking model further comprises synthesizing the profiles to determine a feasibility factor for the service.

11. A non-transitory computer readable medium having stored therein computer executable instructions to:
maintain a knowledge base of profiles for environmental elements and a group of users, wherein each profile comprise at least dependencies, skills, and ratings;
analyze a request for a service from a user to determine a set of resource parameters;
determine relationships for each profile in the knowledge base in view of the request;
generate a ranking model for the profiles based at least on the dependencies of the determined relationships in view of the resource parameters;
prompt the user for feedback on a set of profiles that satisfy the resource parameters based on the ranking;
adjust the ranking model based on similarity calculations of the profiles in view of ratings from the profile of the user;
update the knowledge based on the user feedback; and
provide one or more options based on the adjusted ranking model that satisfy the resource parameters.

12. The non-transitory computer readable medium of claim 11, wherein determining relationships comprises categorizing relationships as at least one of a primary relationship, an adjacent relationship, a direct adjacent relationship.

13. The non-transitory computer readable medium of claim 11, wherein generating the ranking model further comprises synthesizing the profiles to determine a feasibility factor for the service.
